(19) United States
(12) Patent Application Publication
(10) Pub. No.: US 2015/0113404 A1
(43) Pub. Date: Apr. 23, 2015

(54) Publishing Media Content to Virtual Movie Theatres

(71) Applicant: Apple Inc., Cupertino, CA (US)

(72) Inventors: Giovanni Agnoli, San Mateo, CA (US); Keith D. Salvucci, Belmont, CA (US); Randy Ubillos, Los Altos, CA (US); Brian Meaney, Livermore, CA (US); Michael P. Stem, San Francisco, CA (US); Peter M. Tullio, San Francisco, CA (US); Adam J. Leonard, Cambridge, MA (US); Judson L. Coplan, San Francisco, CA (US); Jonathan Cho, San Francisco, CA (US); Daniel Lipton, Belmont, CA (US)

(73) Assignee: Apple Inc., Cupertino, CA (US)

(21) Appl. No.: 14/056,936

(22) Filed: Oct. 17, 2013

(51) Int. Cl. G06F 3/0482; G06F 3/0484

(52) U.S. Cl. CPC G06F 3/0482; G06F 3/0484
USPC 715/719; 715/723

(57) ABSTRACT

Some embodiments of the invention provide a virtual staging area for presenting media content. The virtual staging area of some embodiments is formed by staging areas of multiple different devices in which a same set of content can be viewed. To provide a common viewing experience, the staging areas are presented in a similar manner across different types of user devices. Each staging area may be presented as a virtual movie theatre that has movie posters that advertise user content. A sharing service operates on each of the different devices to facilitate the virtual staging area. The sharing service of some embodiments allows a person to choose a piece of content stored on a device. The sharing service then publishes the content to the device's staging area. From there, the content is then distributed across to the person's other devices.

### BACKGROUND

With advent of digital video, nearly anyone can become an amateur filmmaker. A person does not have to buy expensive camera equipment and film. Instead, the person can just take out a digital camera or mobile device (e.g., smart phone, tablet) and just point and shoot a scene. The person can then use a media editing application to create a media project that combines that video scene with other scenes.

Although it is relatively easy to create a personal movie, there are other challenges in publishing and presenting the movie. For instance, the media project has to be first rendered to file on one computing device. To display the movie on another device, a person must manually import the movie to the other device (e.g., through a removable storage). As for presentation, the movie is typically represented in a folder as a selectable icon or square thumbnail image. In addition, a person might delete, move, or rename a media project media file (e.g., a video clip, an audio clip) or remove a disk drive with the media file. This can cause the media editing application to not render the project or render it without the necessary file.

### BRIEF SUMMARY

Some embodiments of the invention provide a virtual staging area for presenting media content. The virtual staging area of some embodiments is formed by staging areas of multiple different devices (e.g., a smart phone, a tablet, a digital media receiver, a laptop, a personal computer, etc.) in which a same set of content can be viewed. In some embodiments, the devices are all associated with one user. In addition, the content may be user content. To provide a common viewing experience, the staging areas are presented in a similar manner across different types of user devices. Each staging area may be presented as a virtual movie theatre that has movie posters that advertise user content.

To facilitate the virtual staging area, some embodiments provide a sharing service that runs on each of the different devices. The sharing service of some embodiments allows a person to choose a piece of content stored on a device. The sharing service then publishes the content to the device's staging area. From there, the content is then distributed across to the person's other devices. Through the sharing framework, some devices automatically download and store the content for viewing at any time. Other devices do not automatically download the content data. Instead, they just download other data (e.g., poster image, content metadata) to the display the content in the staging area. The content representation (e.g., the poster image) can then be selected from the staging area to stream the content. This streaming feature is particularly useful for user devices without a persistent storage or with a limited amount of storage space.

The sharing service of some embodiments allows content to be distributed across to various user devices. The sharing service may implement one or more different sharing mechanisms (e.g., client-server network, peer-to-peer network). In some embodiments, the sharing service operates as a daemon process on a device to detect that a new content has been published to the device's staging area. The sharing service then interface with a control server to upload the new content to the cloud (e.g., to a storage server). The control server then notifies other user devices of the update. Thereafter, the other user devices may instantaneously download the new content from the cloud.

In some embodiments, the virtual staging area is provided as part of a media editing application for authoring a media presentation. In some such embodiments, the user can use the media editing application's video editing environment to define a media project having a sequence of media items (e.g., video clips, effects, title clips, audio clips, etc.) for a personal movie. The user can then direct the application to publish that media project to the application's staging area. The media editing application might then render the sequence of media items and encode the presentation to a particular encoding format (e.g., high-definition or standard-definition format). The media editing application might also transcode multiple versions of the presentation in different encoding format (e.g., high-definition and standard definition). From the application's staging area, one or more of the fully encoded version of the project is then distributed across to the person's other devices.

In some embodiments, the video editing environment is different from the video staging environment. This is because the video editing environment is for editing a pre-transcoded video presentation and the staging area is for viewing a transcoded video presentation. For instance, the video editing environment provides various tools to edit a video presentation. Different from the video editing environment, the video staging environment of some embodiments provides a staging area (a virtual theatre) with representations (e.g., poster image) of different video presentations. Each representation can be selected by a person to play the corresponding content in the staging area. In conjunction with the transcoded version or instead of it, the staging area of some embodiments enables viewing of a rendered version of the video presentation. The rendered version is the version that is rendered from a set of media clips by the media editing application prior to transcoding one or more transcoded versions (e.g., from the rendered version or from the set of media clips).

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE FIGURES

The novel features of the invention are set forth in the appended claims. However, for purposes of explanation, several embodiments of the invention are set forth in the following figures.

FIG. 1 illustrates an example of a virtual staging area that presents content on different user devices.

FIG. 2 illustrates an example of the sharing mechanism of some embodiments of the invention.

FIG. 3 illustrates another example sharing mechanism that allows content to be streamed.

FIG. 4 illustrates an example of authoring a media presentation with a media editing application.

FIG. 5 illustrates an example of publishing the project to a staging area.

FIG. 6 conceptually illustrates an example process that some embodiments use to publish content to a staging area.

FIG. 7 illustrates an example of pushing content onto a tablet.

FIG. 8 illustrates an example of how the new content is pushed another user device.

FIG. 9 illustrates an example of such a device that streams content.

FIG. 10 illustrates an example of using one device to remove the published content on another user device.

FIG. 11 illustrates an example of how the sharing service can be integrated into an operating system.

FIG. 12 illustrates an example of how the sharing service can be integrated into an application.

FIG. 13 illustrates another example of how the sharing service can be integrated into an application.

FIG. 14 conceptually illustrates content metadata according to some embodiments.

FIG. 15 conceptually illustrates a process that some embodiments use to publish a video presentation.

FIG. 16 conceptually illustrates an example system architecture in which the clients communicate with the different servers to share content.

FIG. 17 conceptually an example of how content stored on one user device is sent to a storage sever for distribution to other user devices.

FIG. 18 conceptually illustrates a process that some embodiments use to publish content to the cloud.

FIG. 19 conceptually illustrates a process that some embodiments use to publish content to the cloud.

FIG. 20 illustrates an example of how such a device downloads content from a storage server.

FIG. 21 conceptually illustrates a process that some embodiments use to push content to other client devices.

FIG. 22 illustrates an example of how such a device streams content from a storage server.

FIG. 23 conceptually illustrates a software architecture of the share service of some embodiments.

FIG. 24 is an example of an architecture of such a mobile computing device.

FIG. 25 conceptually illustrates another example of an electronic system with which some embodiments of the invention is implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a virtual staging area for presenting media content. The virtual staging area of some embodiments is formed by staging area environments of multiple different devices (e.g., a smart phone, a tablet, a digital media receiver, a laptop, a personal computer, etc.) in which a same set of content can be viewed. In some embodiments, the devices are all associated with one user. In addition, the content may be user content. To provide a common viewing experience, the staging areas are presented in a similar manner across different types of user devices. Each staging area may be presented as a virtual movie theatre that has movie posters that advertise user content.

To facilitate the virtual staging area, some embodiments provide a sharing service that runs on each of the different devices. The sharing service of some embodiments allows a person to choose a piece of content stored on a device. The sharing service then publishes the content to the device's staging area. From there, the content is then distributed across to the person's other devices. Through the sharing framework, some devices automatically download and store the content for viewing at any time. Other devices do not automatically download the content data. Instead, they just download other data (e.g., poster image, content metadata) to the display the content in the staging area. The content representation (e.g., the poster image) can then be selected from the staging area to stream the content. This streaming feature is particularly useful for user devices without a persistent storage or with a limited amount of storage space.

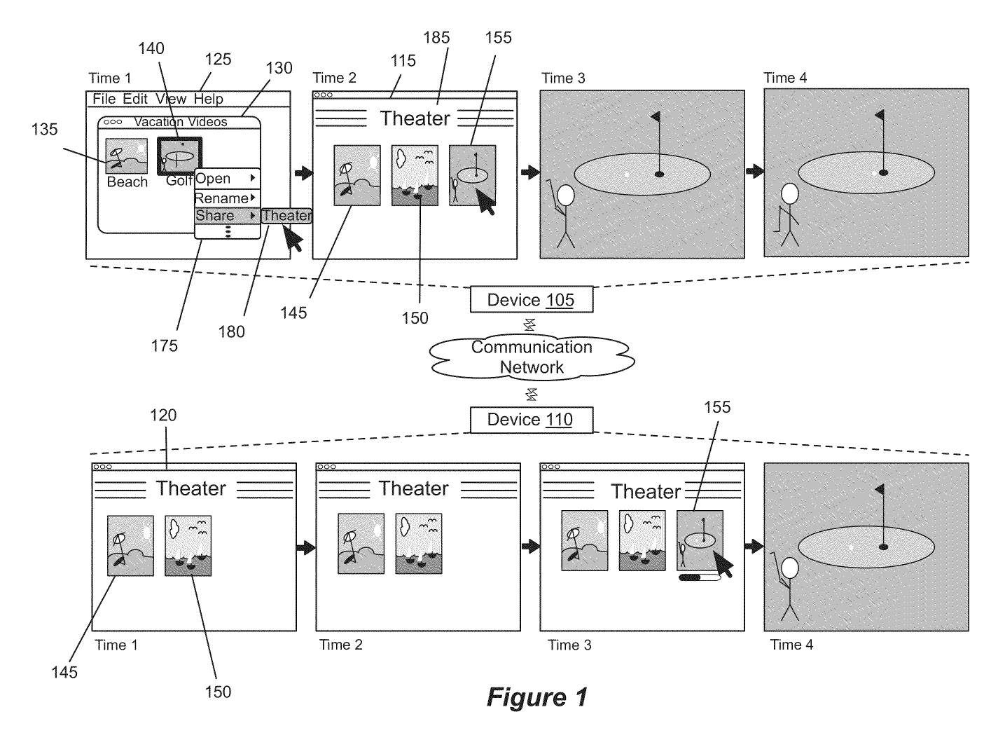

For some embodiments of the invention, FIG. 1 illustrates an example of a virtual staging area that presents content on different user devices. Specifically, this figure illustrates publishing a video to a staging area 115 of a first device 105. It also shows how the published video is pushed to a second device 110 and appears in a staging area 120 of the second device. This figure conceptually illustrates the devices 105 and 110 at five different time periods (time 1-time 5).

At time 1, the device 105 is displaying a file manager 125 to manage files, disks, network volumes, and launch applications. A file manager widow 130 has been opened to display contents of a folder. The folder is named “Vacation Videos”. The folder contains several video clips 135 and 140. To publish the clip 140, the device's user has selected its thumbnail representation from the window 130 (e.g., through a right-cursor click or a cursor click in conjunction with holding down a key). The selection resulted in the display of a context menu 175.

The context menu 175 includes a number of selectable items. To simplify the discussion, the context menu 175 only includes selectable items to open, rename, and share the video clip. However, it can include more items or even fewer items. At time 1, the user has selected the item to share the video clip 140. The selection has resulted in the context menu to expand and reveal an option 180 to publish the video clip to a staging area 115 (e.g., a virtual theatre). The user then selects the option 180 to publish the video clip.

At time 2, the video clip 140 has been published to the staging area 115 of the device 105. The staging area 115 has also been launched on the device 105. In some embodiments, the staging area is automatically opened upon selecting the option 180 to publish a piece of content to the staging area 115. The staging area 115 shows a representation 155 of the published video, as well as representations 145 and 150 of two other video that were published at an earlier time.

The staging area 115 is presented as a virtual movie theater. In particular, the staging area 115 is shown with a designed label 185 that states that it is a “theatre”. Each of the videos is presented in the theatre with an image (e.g., thumbnail image) that has a same format as a movie poster. The image has a portrait orientation, and is not a square icon representation as shown in the file browser window 130. Similar to a movie title, the name of the video may be written at least partially across the poster image. The user can select anyone of the poster images from the virtual theatre to play the corresponding video.

The user selects (at time 2) the poster image 155 from the staging area 115. The selection causes the video to be played back on the device 105. The content playback may be accompanied by animation to immerse the audience in a virtual movie going experience. An example of such an animation is curtains opening when playback begins and closing when the playback ends. To further immerse the audience, any published content that is opened with a staging area is always or by default played in full-screen mode rather than a windowed mode. This is shown at time 3 because the published video is played back in full-screen.

As mentioned above, when a piece of content is published to a staging area of one user device, the same piece of content is pushed across to multiple other user devices. At time 1 and time 2, a staging area 120 has been opened on the other device 110. The staging area 120 appears similar or identical to the staging area 115. It appears as a virtual movie theatre with poster images of published content. However, the video clip has yet to be pushed onto this device 110. Accordingly, the staging area 120 only shows the same poster images 145 and 150 of the two other videos that were published at an earlier time.

At time 3, the first device 105 is playing the published video. The same video is now being pushed onto the other user device 110. In particular, the staging area 120 shows the poster image 155 of the video clip. The poster image 155 is shown with a progress bar 155. This bar indicates the amount of content data that has been downed onto that device 110. In some embodiments, a staging area allows playback of content during download. For instance, a person selects (at time 3) the image 155 from the staging area (e.g., through a cursor click operation). The selection causes the video to be played back on the device 155. At time 4, both the devices 105 and 110 are simultaneously playing the same video. The second device 110 is playing a later portion of the video, while the first device 105 is playing an earlier portion.

In the example described above, the user uses a context menu to choose a video clip to publish to a staging area. Alternatively, or conjunctively with the context menu, the virtual staging area of some embodiments allows a person to drag and drop a media item onto the staging area. For example, when the staging area has been opened, the person can publish a media item by selecting a media item, and dragging and dropping the media item directly onto the staging area. In addition, one of ordinary skill in the art would understand that the context menu is just one example way of selecting an item to publish. That is, the same feature can be implemented in numerous other ways (e.g., through a tool bar button, a drop-down menu, etc.).

The previous example also illustrated publishing a video clip. In some embodiments, the virtual theatre presents other types of content, including audio clips and slide show presentations. As will be described below, the virtual staging area of some embodiments is integrated with a media editing application. In some such embodiments, the user can use the media editing application to define a media project having a sequence of media items (e.g., video clips, effects, title clips, audio clips, etc.) for a personal movie. The user can then direct the application to publish that media project to the application's staging area. The media editing application might then render the sequence of media items and encode the presentation to a particular encoding format (e.g., high-definition or standard-definition format). The media editing application might also transcode multiple versions of the presentation in different encoding format (e.g., high-definition and standard definition). From there, the content is then distributed across to the person's other devices.

The sharing service of some embodiments allows content to be distributed across to various user devices. The sharing service may implement one or more different sharing mechanisms between two or more devices. Examples of such sharing mechanism include direct peer-to-peer connections, or indirect connections that traverse through cloud infrastructure. An example of an indirect connection would be a first device that uploads video content to a set of one or more servers, which then supply the video content to a second device. This type of indirect connection can be viewed as an indirect peer-to-peer connection that is facilitated by communication and storage of content in the cloud.

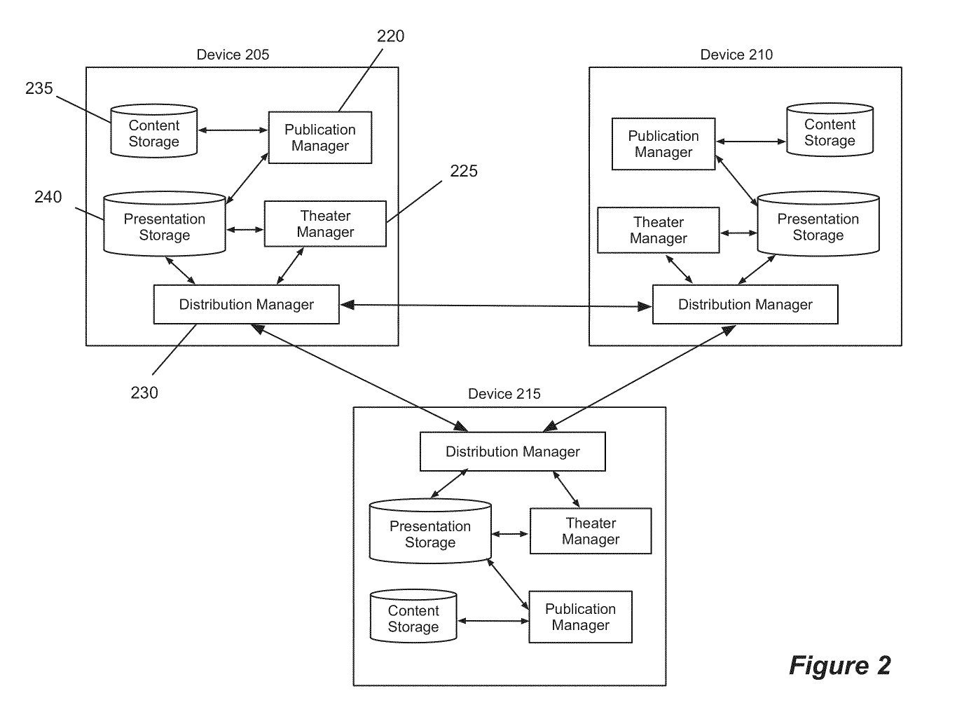

FIG. 2 illustrates an example of the sharing mechanism of some embodiments of the invention. This figure illustrates three user devices 205-215 that are communicatively coupled any number of different ways, including through Wi-Fi network, through short-range radio communication (e.g., near field communication (NFC), Bluetooth), the Internet, etc. Also, as described above and further below, each communication link between the devices can be established through a cloud infrastructure that receives content from one device and distributes the content to the other devices for storage or streaming.

As shown in FIG. 2, each device includes (1) a publication manager 220, (2) a theater manager 225, and (3) a distribution manager 230. The figure also show several storage, namely content storage 235 that store content, and presentation storage 240 that stores published content for presentation. For illustrative purpose, the content and presentation data are stored in separate storages but may be stored in just one readable medium, in some embodiments.

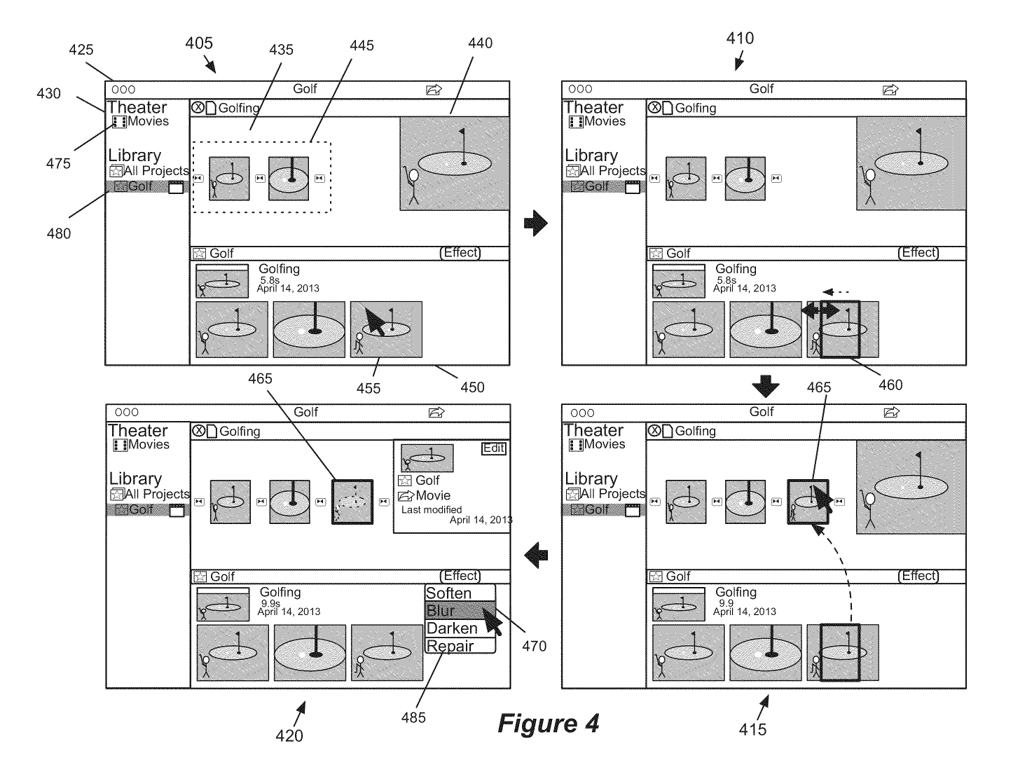

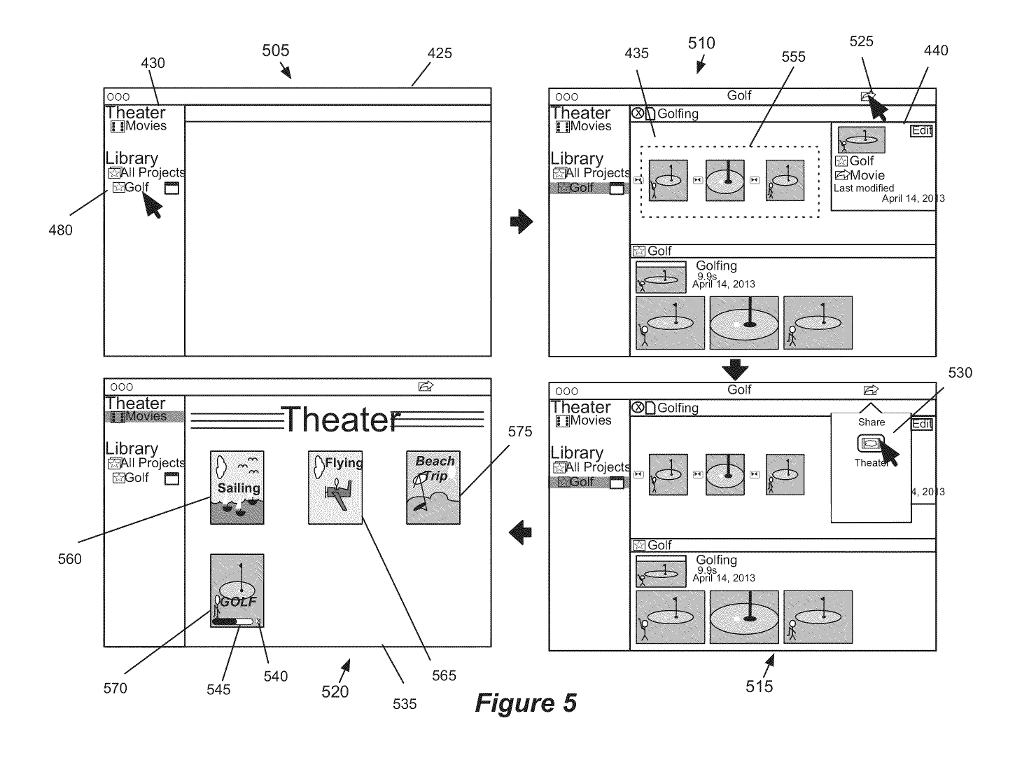

The publication manager 220 operates on each device to publish content to a staging area (e.g., a virtual theatre). In some embodiments, the publication manager 220 receives identification of a piece of content and generates one or more versions (e.g., high-definition and standard definition) to share with the other user devices. The publication manager 220 may interact with one or more encoding modules to generate the different versions. Alternatively, the publication manager may not generate different versions but simply copy the content file to the presentation storage. For instance, when a user selects a video clip file, the video clip file may be transferred to a special directory (e.g., a theatre folder, a share folder). This folder contains all items shared between user devices. For sharing media projects, the publication manager 220 may operate in conjunction with a rendering engine and one or more encoding modules. Examples of authoring and publishing media projects are described below by reference to FIGS. 4 and 5.

The theatre manager 220 generates a presentation of the staging area on each device. In some embodiments, this manager is responsible for providing a common viewing experience across the different user devices 205-215. For example, the staging area may be presented as a virtual theatre with movie posters that advertise published content. The user can select any one of the movie posters to play that movie (e.g., in a full-screen mode). The presentation may also be accompanied by animation, such as curtains that open at the beginning of the playback and closes at the end.

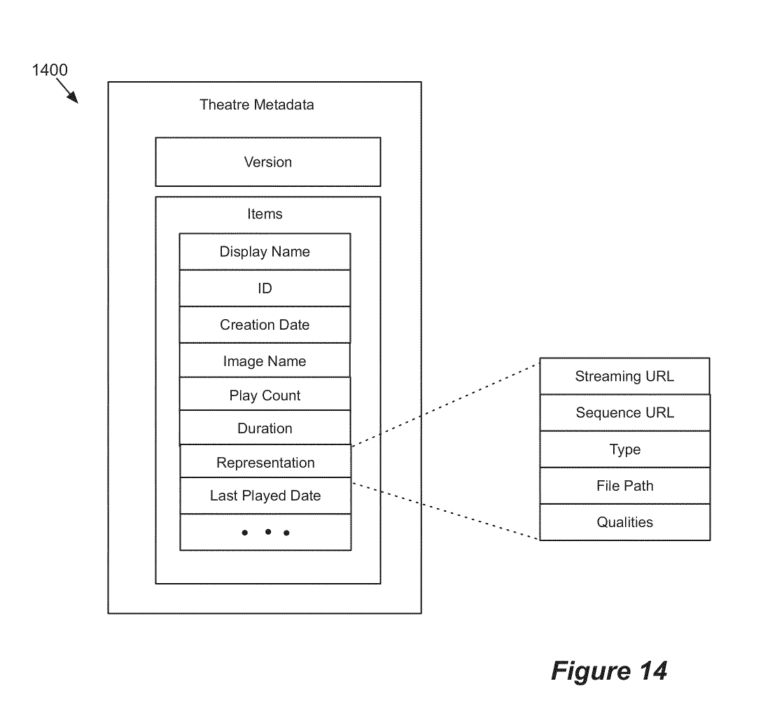

To provide a common viewing experience, the theater manager 225 may receive and keep track of content metadata for each piece of published content. The content metadata of some embodiments includes information that is used to present the published content. As a first example, theatre managers of different devices might use a same play count associated with a media clip to prominent feature that media clip the different devices. Similarly, the theatre managers may use metadata relating to a last played time of a media clip to show a list of previously played content. Several additional example of such a content metadata is described below by reference to FIG. 14.

The distribution manager 230 is responsible for distributing content to other user device. In some embodiments, the distribution manager detects newly published content and notifies the other devices to retrieve the published content (e.g., from the presentation storage). Alternatively, the distribution manager might push the content to each of the other user devices.

The distribution manager uses different distribution mechanisms to share content between devices. Examples of such distribution mechanism include direct peer-to-peer connections, or indirect connections that traverse through cloud infrastructure. As mentioned above, the cloud infrastructure receives content from one device and distributes the content to the other devices for storage or streaming. Alternative or conjunctively, the distribution manager in some embodiments uses other mechanisms for sharing content between devices, such as establishing connections between devices through Wi-Fi network, through short-range radio communication (e.g., near field communication (NFC), Bluetooth), or peer-to-peer connections through the Internet, etc. Accordingly, in different embodiments, the distribution manager uses different communication links and different sharing mechanism to establish communication between devices and to share content between devices.

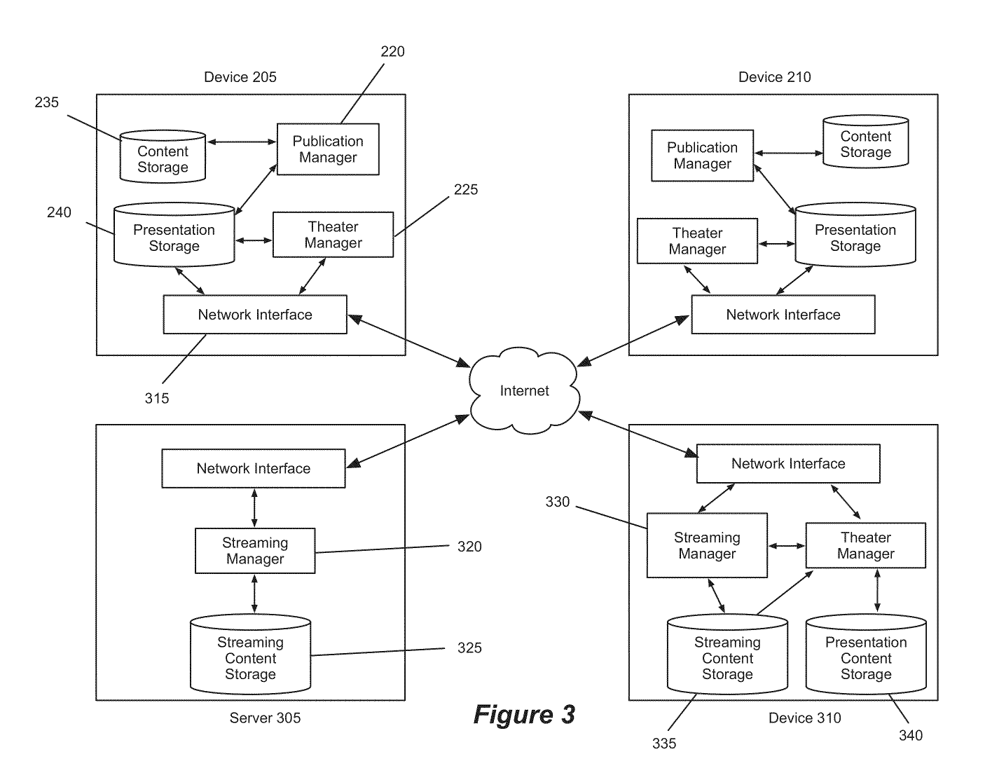

FIG. 3 illustrates another example sharing mechanism. This mechanism not only allows video content to be distributed from a first device to a second device, but also allows the content of the first device to be stored in the cloud (i.e., stored on a set of one or more servers 305) from which a third device 310 can stream the content. While the third device does not receive and store the video content from the first device and only streams video content from the set of servers 305 when it needs this content, the third device in some embodiments receives and stores some amount of data from the first device (through the set of servers) regarding the video content. For instance, in order to display some amount of data for the video content in its staging area, the third device of some embodiments stores poster image and content metadata for the video content from the first device (through the set of servers). A user can then review the poster image for the video content in the staging area to identify the video clip and determine whether to stream the content.

As shown, each of the devices 205, 210, and 310 are connected to the Internet through a network interface 315. Similarly, a server 305 that streams content to the device 310 is connected to the Internet through the same network interface. The server 305 includes a stream manager 320 that accesses streaming content storage to stream content to the device 310. Different from other user devices 205 and 210, the device includes a streaming manger 330 to stream content from the server 305. The device also includes a presentation content storage 340. Different from the presentation storage, this storage stores other data (e.g., content metadata, thumbnail poster image) to present published content in the device's staging area.

As mention above, the media editing application of some embodiments allows a user to author a media presentation, render the presentation to a file, and published the rendered version to a staging area. As an example, the user can use the media editing application to define a media project having a sequence of media items (e.g., video clips, effects, title clips, audio clips, etc.) for a personal movie. The user can then direct the application to publish that media project to the application's staging area. The media editing application might then render the sequence of media items and encode the presentation to a particular encoding format (e.g., high-definition or standard-definition format). The media editing application might also transcode multiple versions of the presentation in different encoding format (e.g., high-definition and standard definition). From there, the content is then distributed across to the person's other devices. Several examples of such a media editing application will now be described below by reference to FIGS. 4-7.

FIG. 4 illustrates an example of authoring a media presentation with a media editing application. Specifically, it illustrates how the media editing application can be used to define a project (e.g., a personal movie project) that includes a sequence of media items. Four operational stages 405-420 of the media editing application are shown in this figure. As shown, the media editing application includes graphical user interface (GUI) 425. The GUI 425 has a library 430, a media browser 450, a timeline 435, and a preview display area 440.

The library 430 includes a list of items through which its user accesses media projects. That is, it shows a representation of each media project that when selected opens the corresponding project. In the example of FIG. 4, the library 430 also includes a selectable item 475 to open the application's staging area (e.g., a virtual theatre).

The clip browser 450 displays media content (e.g., images, video clips, audio clips) imported with the application. Here, the clip browser 450 displays thumbnail representations of several video clips. However, depending on the view settings, the may be represented differently. For instance, a video clip may be represented as a filmstrip with several frames displayed as a sequence of thumbnail images. Different from a video clip, an audio clip may be represented as a waveform. That is, a representation of the audio clip may indicate the clip's signal strength at one or more instances in time. In some embodiments, a video clip representation may include a representation of its associated audio.

The timeline 435 provides a visual representation of a composite presentation (or project) being created by the user of the media-editing application. Specifically, it displays one or more geometric shapes that represent one or more media clips that are part of the composite presentation. The user can select any content from the clip browser 450 and add that content to the timeline 435. Within the timeline, the user can perform further edits to the media clips (e.g., move the clips around, split the clips, trim the clips, apply effects to the clips, etc.). The preview display area 440 (also referred to as a “viewer”) displays images from media files, which the user is skimming through, playing back, or editing. These images may be from a composite presentation in the timeline 435 or from a video clip in the clip browser 450.

Having described several example elements of the GUI 425, the operations of adding a video clip and an effect to a media project will now be described by reference to the state of this GUI during the four stages 405-420 that are illustrated in FIG. 4. In the first stage 405, the library 430 displays a list of projects. The user has selected the project 480 from the list to display in its timeline representation 445 in the timeline 435.

As shown in the first stage 405, the timeline 435 displays a visual representation of the selected project 480. Specifically, it show several clip representations in sequence. The sequence represents the order in which the corresponding clips are played back in the output presentation. Here, only video clips are included in the project. However, the project can include different type of media items, such as audio clips, titles (e.g., opening title, end credits), sub-titles, still images, etc. In the example of FIG. 4, the timeline 435 also includes a marking (e.g., an icon) between two clip representations. The marking in some embodiment represents a transition effect. A transition effect is an effect that is applied to smooth or blend the change from one scene to another. The transition effect can also be used to fade in or out, dissolve into another clip, zoom in to another clip, etc. One of ordinary skill in the art would understand that the visual representation 445 in the timeline 435 is one example representation and that different embodiments can differently present media items associated with a project. For instance, the composite presentation can be shown on one or more tracks with clip representations. Alternatively, the timeline may include a primary lane with a clip sequence as well as one or more secondary lanes with secondary clip sequences.

The first stage 405 illustrates the selection of a video clip to add to the sequence of clips shown in the timeline 435. Specifically, the user selects the clip representation 455 from the clip browser 450. As shown in the second stage 410, the selection causes a range selector 460 to appear over the representation 455. This range selector 460 can be used to select a portion of the clip to add to the composite presentation. That is, instead of selecting the entire duration of the clip, the range selector 460 can be adjusted to select a range of the clip (e.g., the first, middle, or last portion of the clip). This tool is particular useful when the clip browser 450 is set to display a filmstrip representation of each video clip, as it allows the user to view different frames and then select the range by reference to these frames.

The second stage 410 shows the user interacting with the range selector 460 to select a range of the video clip. Specifically, the left edge of the range selector 460 is moved along the representation 455 to select a portion of the clip. As shown in the third stage 415, the user then adds the portion of the clip to composite presentation through a drag and drop operation of that portion to the timeline 435. Alternatively, the user can select a menu item or a shortcut key to add the portion.

The fourth stage 420 illustrates the user adding an effect to a media project. Many different effects can be used to enhance a composite presentation. Examples of such effects include transition effects (e.g., described above), audio effects (e.g., reverb, echo), video effects (e.g., different video filters), etc. To simplify the discussion, the fourth stage 420 only shows four different effects, namely soften, blur, darken, and repair effects. The effects are shown in a drop down list 485. The representation 465 has been selected in the timeline 435. The user selects the blur effect 470 from the list 485 to blur the corresponding clip portion.

The previous example illustrated authoring a media project with the media editing application. FIG. 5 illustrates an example of publishing the project to a staging area. In particular, this figure shows in four operational stages 505-520 how the media edging application can be used to publish one or more rendered and encoded versions of the composite presentation to the application's staging area. The media editing application is the same as the one described in the previous figure

In the first stage 505, the library 430 displays a list of projects. To open the project 480, the user selects it from the list. As shown in the second stage 510, the selection causes the timeline 435 to display a visual representation 555 of the selected project 480. Specifically, it shows several clip representations in sequence. The sequence represents the order in which the corresponding clips are played back in the output presentation. In this example, the preview display area 440 acts as an inspector window that displays information relating to the project. The window shows the project title, an image in the presentation, the date last modified, etc.

The second stage 510 illustrates selecting an option to publish the composite presentation to the staging area 535. The media editing application includes a selectable item 525 (e.g., a share button) to reveal a list of share options. As shown in the third stage 515, the list includes an option 530 to publish the composite presentation to the staging area 535.

In the third stage 515, the user then selects the option 530 to publish the project. As shown in the fourth stage 520, the selection causes the media editing application to display the staging area 535. The staging area 535 shows representations 560-575 of the published media content and the project that is being rendered to file. In some embodiments, the media editing application also renders an image (e.g., a poster image) so that it can be displayed in the virtual staging area. That is, the media editing application generates an image that is presented in staging areas of multiple different devices. Similar to the rendered composite presentation, the sharing service of some embodiments publishes the rendered image to a staging area. From there, the rendered image is then distributed across to other user devices.

As shown in the fourth stage 520, the representations 560-575 are depicted in the staging area 535 as movie poster images. The media editing application of some embodiments renders a poster image using the title and image associated with the project. If a project is associated with a theme, the media editing application may generate the poster image based on that theme. For instance, the media editing application may provide a number of different themes (e.g., action, adventure, documentary, scrapbook, news, comic book) that define the overall presentation of the composite presentation, including the appearance of the title (e.g., the title's font and size) and the title image. When a project is associated with a theme, the media editing application might renders the poster image by performing any one or more of the following: filtering an image to appear a certain way (e.g., black and white), compositing text (e.g., designed title, credit, rating, etc.) over the image, and cropping the image so that it has a portrait orientation.

The fourth stage 520 illustrates a progress bar 545 over the representation 570. This bar 545 provides a visual indication of the progress of generating an output file (i.e., a rendered and encoded version of the media project). The user can select the cancel button 540 to direct the application to cancel the output operation. The user can also select the poster image 570 to play the presentation as it is being rendered. That is, the user does not have to wait for the project to be fully output to file but can play the presentation before the media editing application completes the output operation. The media editing application of some embodiments renders a sequence of media items associated with a project and encodes the presentation to a particular encoding format (e.g., high-definition or standard-definition format). In rendering, the media editing application might generate one or more render lists based on the sequence of media items associated with the project. The media editing application might then perform one or more rendering passes on each render list to render the project using the source media items (e.g., video clip files, audio clip files, images, etc.).

In some embodiments, the media editing application transcodes multiple versions of the presentation in different encoding format (e.g., high-definition, standard definition). The media editing application of some embodiments first transcode a higher quality version of the source media (e.g., the project sequence). Once the high quality version is transcoded, the sharing service uploads the content metadata to the cloud (e.g., to a control server), and then uploads the poster image to the cloud (e.g., to a storage server). After uploading the poster image, the sharing service then uploads the high quality version to the cloud (e.g., the storage server).

The sharing service in some embodiments operates as a background process even if the media application is not open and has been closed. In other words, the uploading of content will continue even though the application has been closed. Different from uploading, the transcoding may not continue if the media editing application is closed. Specifically, if the media editing application is closed, the transcoding of a version of the source media (e.g., the project sequence) will be canceled. When the application is re-launched, the media editing application of some embodiments then automatically transcodes that same version (e.g., as a background task).

The sharing service may also facilitate distribution of the different versions. For example, the high-definition version may be distributed to all one or more other user devices that are connected to internet through Wi-Fi. On the other hand, the standard definition version might be distributed or streamed to user devices using the cellular network (e.g., using 3G, 4G technology). The virtual staging area of some embodiments always tries to play the highest quality version that is available. If the content is being streamed, the virtual staging area plays a version that would not stall during playback. For example, if the a version of a user's movie is streamed at a bit rate higher than the available bandwidth of the connection, playback of the movie will eventually stop in order to wait for additional portions of the content to download.

One of the benefits of publishing a project to a staging area is that it allows a person to keep a fully encoded version of the project even when the project is deleted or there are broken links with source media items. As a first example, a person might one day use the media editing application to delete a project. However, the published version of that project will be retained on one or more user devices. As a second example, the person might delete, move, or rename a project asset file (e.g., a video clip, an audio clip, a still image) or remove a disk drive with the asset file. This can cause the media editing application to not render the project or render it without the necessary file. Thus, the publication feature is an easy mechanism to save projects without the author worrying about having the project fall apart if the assets are lost.

One of the unique features of the virtual staging area is that a piece of content (e.g., a movie) can be added to a staging area (e.g., a movie theatre) and played while the piece of content is being transcoded into one or more versions. Typically, a person has to upload content to a site and then has to wait for a certain amount of time (e.g., a couple of hours) for the site to finish transcoding different versions of the clip prior to playing the content. However, with the staging tools, a user can input a command to publish a project and then select the corresponding poster image from the staging area to play the presentation (e.g., the transcoded portion) while the project being transcoded in the background.

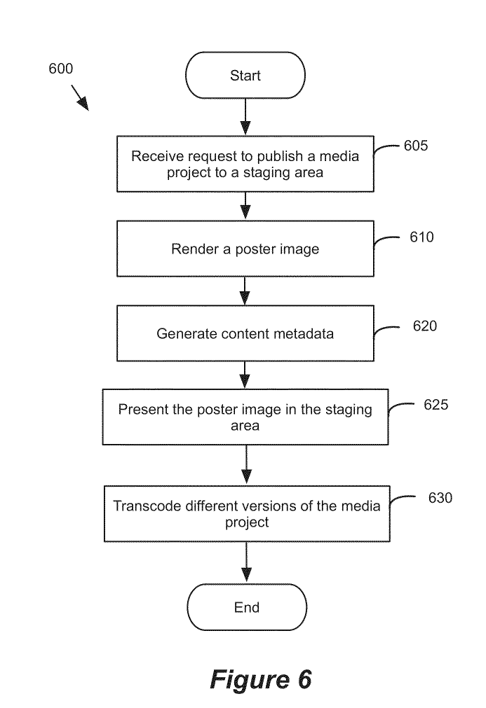

FIG. 6 conceptually illustrates an example process 600 that some embodiments use to publish content to a staging area. In this example, the content is a media project. Also, a media editing application performs these operations. However, the process might be performed by another application (e.g., a theatre application, a photo application) or a service module associated with an operating system.

As shown, the process 600 begins when it receives (at 605) a request to publish a media project to a staging area (e.g., a virtual movie theatre). The process 600 then renders (at 610) a poster image. This is the same poster image that is shown across all staging areas of different devices. As mentioned above, the media editing application of some embodiments renders a poster image using the title and image associated with the project. If a project is associated with a theme, the media editing application may generate the poster image based on that theme.

At 615, the process 600 generates content metadata. The content metadata describes a shared content and its presentation in the virtual staging area across different types of user devices. An example content metadata is described below by reference to FIG. 14. The process 600 presents (at 625) the poster image in the staging area. The process 600 then transcode difference version of the media project. For example the process 600 might transcode both high definition and standard-definition version of the media project.

In some embodiments, the process 600 first transcode a higher quality version of the source media (e.g., the project sequence). Once the high quality version is transcoded, the process 600 or the sharing framework uploads the content metadata to the cloud (e.g., to a control server), and then uploads the poster image to the cloud (e.g., to a storage server). After uploading the poster image, the process 600 or the sharing framework uploads the high quality version to the cloud (e.g., the storage server).

While the upload is taking place, the process 600 of some embodiments transcodes a lower quality version. When the transcoding is complete, the process 600 or the sharing service upload the lower quality version to the cloud (e.g., to the storage server). One of the reasons why the lower quality version comes out last is because it is assumed that people will most likely want to view the high quality version, instead of the lower quality version. If the lower quality version came out first, then a person using a different device has to wait for the lower quality version to be uploaded and then the high quality version before the high quality version can be downloaded onto or streamed on that device.

Some embodiments perform variations of the process 600. The specific operations of the process may not be performed in the exact order shown and described. The specific operations may not be performed in one continuous series of operations, and different specific operations may be performed in different embodiments.

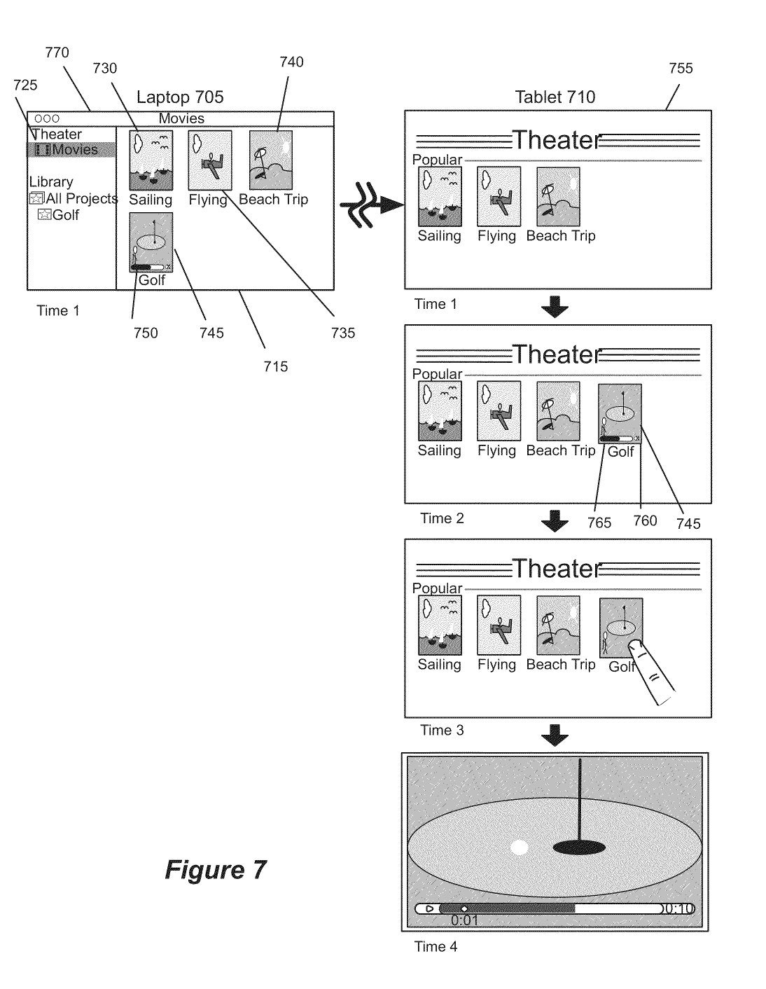

As mentioned above, the sharing service of some embodiments publishes content to a staging area. From there, the content is then distributed across to other user devices. Some devices automatically download and store the content for viewing at any time. Other devices do not automatically download the content data. Instead, they just download other data (e.g., poster image, content metadata) to display the content in the staging area and stream the content (e.g., from a server) when directed by a person. Several such distribution examples will now be described by reference to FIGS. 7-9.

FIG. 7 illustrates an example of pushing content onto a tablet. Specifically, this figure illustrates how a rendered and encoded version of a media project that is published to a staging area on a user's laptop 705 appears on the user's tablet 710. The laptop and the tablet may be at a same location or at different remote locations. This figure conceptually illustrates four periods (time 1-time 4).

At time 1, the media editing application 770 has been opened on the laptop 705. A user has directed the application to publish a composite presentation to the application's staging area 715. The staging area 715 shows representations 730-745 (e.g., poster images) of the published media content and the project that is being rendered to file. The representation 745 is shown with a progress bar 750. This bar provides a visual indication of the progress of the output operation. The user can select the representation 745 to play the presentation as it is being rendered. That is, the user does not have to wait for the composite presentation to be fully output to file but can play the presentation before the media editing application completes the rendering operation. A separate staging area 755 has (at time 1) been launched on the tablet. However, the staging area 715 only includes representations 730-740 of the previously published content. This is because the project (at time 1) is being rendered to file.

At time 2, the project has been rendered to file on the laptop 705. The media editing application might have transcoded multiple versions in different encoding format (e.g., high-definition and standard definition). A sharing service that executes on the laptop might have transmitted one or more output versions, content metadata, and a poster image to a cloud service (e.g., a storage server). The sharing service executing on the tablet detects that a new content has been published and instantaneously downloads one or more of the output versions, the content metadata, and the poster image from the cloud service. In some embodiments, the sharing service is a daemon process that runs in the background to detect and download new content to add to a staging area. For instance, the sharing service may operate in the background to download content even when the staging area 755 has not been opened on the tablet 710.

The tablet's staging area 755 shows (at time 2) the representation 745 (also referred to as a poster image). The poster image 745 is shown with a progress bar 765. This bar indicates the amount of content data that has been downloaded on that tablet 710. At this time, the user can select the cancel button 760 to cancel the download. The poster image 745 can also be selected to play the output version while it is being downloaded.

At time 3, one or more versions of the rendered project have automatically been pushed onto the tablet through the tablet's sharing service. Accordingly, the staging area 755 presents the poster image 745 without the download progress bar 765. A person selects the newly published content by tapping the person's finger on the touchscreen display over the poster image 745. The selection causes the content to be played back on the tablet 710. At time 4, the new content is being played on the tablet 710.

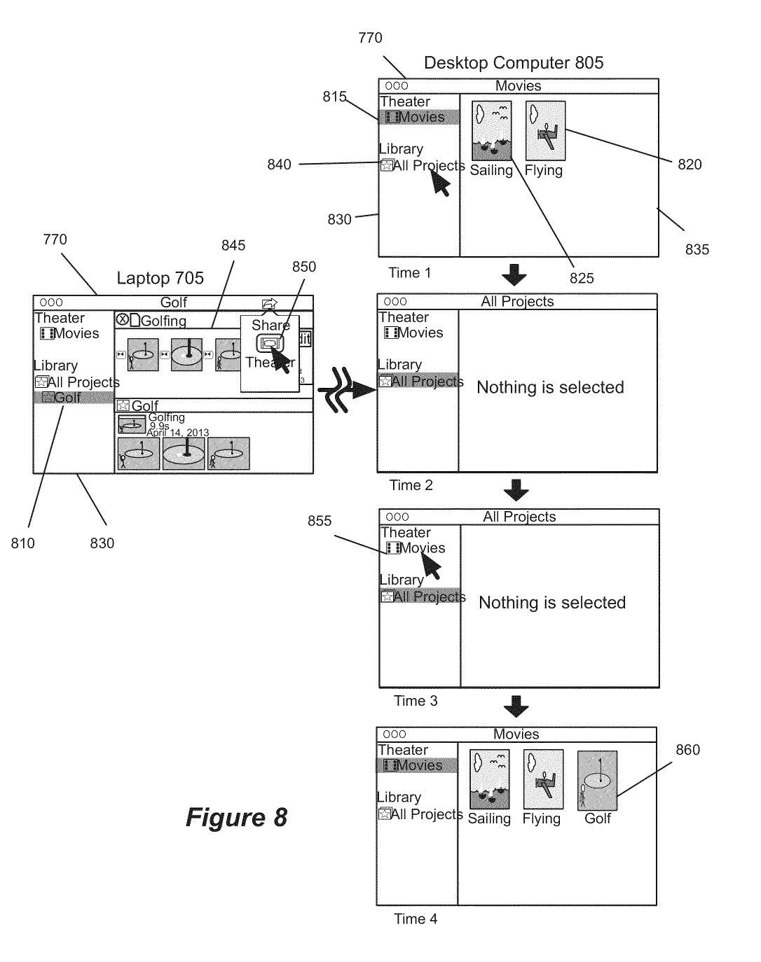

FIG. 8 illustrates an example of how the new content is pushed to another user device. In particular, this figure illustrates how a project that is published to the staging area of the laptop 705 appears on a desktop computer 805. The laptop 705 and the desktop computer 805 may be at a same location or at remote locations. This figure conceptually illustrates four periods (time 1-time 4).

At time 1, the media editing application 770 has been launched on the desktop 805. The application 770 is the same as the one that executes on the laptop 705. However, the application may be a different application (e.g., a photo organizing application) that implements the virtual staging area of some embodiments. As shown, the staging area option 815 has been selected from the library 830. The selection has resulted in the media editing application displaying the staging area 835. The staging area 835 shows representations 835 of the previously published content. To display the list of project, the user selects an item 840 from the library 830 labeled “All Projects”. However, as shown in time 2, the application has not been used to author any project.

At time 2, the same media editing application 770 has been opened on laptop 705. A project 810 has been selected from the library 830. In response to the selection, the media editing application presents a visual representation of the project in the timeline 845. At this time, the user selects the option 850 to publish the project to the application's staging area 850.

At time 3, the project has been rendered to file on the laptop 705. The media editing application 770 might have transcoded multiple versions of the project in different encoding format (e.g., high-definition and standard definition). The sharing service executing on the laptop 705 has transmitted one or more output versions, its associated metadata, and a poster image to a cloud service (e.g., a storage server). The sharing service executing on the desktop computer 805 has detected that a new content has been published. The sharing service has also downloaded one or more of the output versions, its associated metadata, and the poster image onto the desktop computer 805.

As shown, the user selects (at time 4) an item 855 from the library 830 to show the application's staging area 835. The staging area 835 shows representations 820 and 825 of the published media content. The staging area 835 also show a representation 860 of the new content published with the laptop 705. As mentioned above, one of the benefits of publishing a project to a staging area is that it allows a person to keep one or more fully encoded versions of the media project even when the project is deleted or there are broken links with source media items. In this example, at least one encoded version of the project is not only stored on the laptop 705 but also the desktop computer 805.

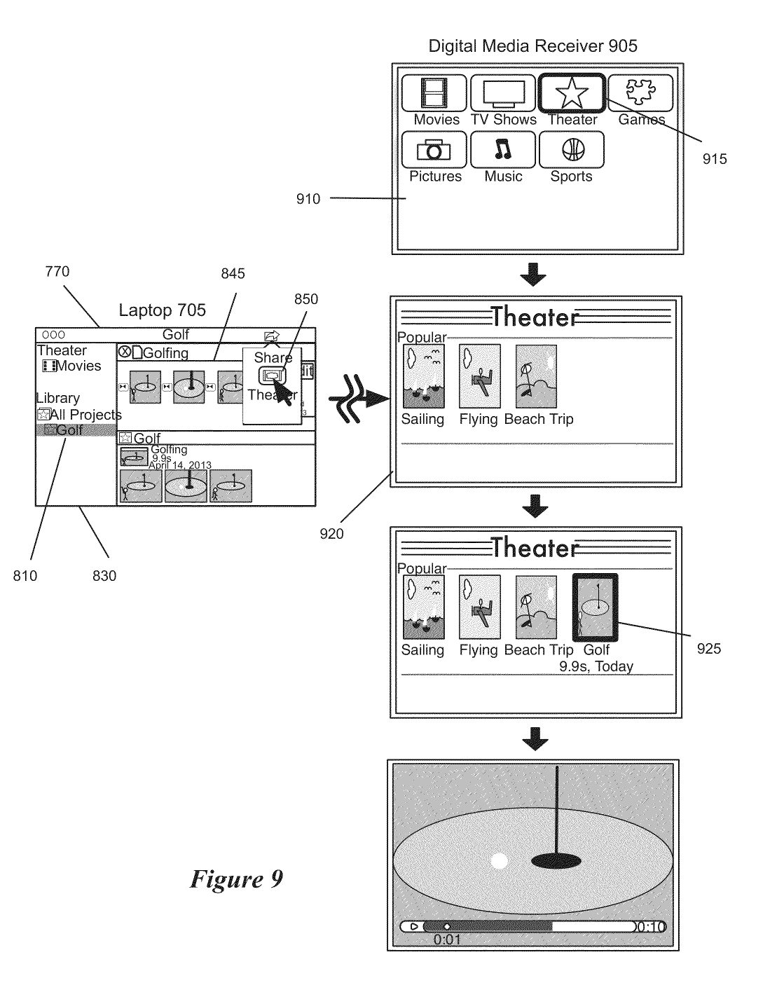

The previous two figures illustrated example devices that automatically download and store the content for viewing at any time. As mentioned above, other devices do not automatically download the content data. Instead, they just download other data (e.g., poster image, content metadata) in order to display the content in the staging area and stream the content (e.g., from a server) when directed by a person. FIG. 9 illustrates an example of such a device that streams content. Here, the device is a digital media receiver 905 but can be any device (e.g., smart television, a gaming console; or any other device with limited amount of storage and/or without a persistent storage). This figure conceptually illustrates four periods (time 1-time 4).

At time 1, the digital media receiver 905 has generated a display of its operating system's home screen 910. The home screen 910 includes several icons for opening different applications. Here, the icons include a theater icon 915 for opening the staging area application. Different from the previous example, the staging area application of the digital media receiver 905 is a stand-alone application for viewing published content. That is, the staging area application is not an authoring application to create new media project. As shown, the theatre icon 915 has been selected from the home screen 910. At this time, the user can direct the digital media receiver 905 to launch the staging area application (e.g., by selecting a button on the device's remote control).

At time 2, the staging area application has been launched on the digital media receiver. The staging area 920 shows poster images 925-935 of the previously published media content. The content may not be stored in any of the digital media receiver's storage (e.g., cache storage). In some embodiments, the staging area application dynamically presents the staging area by downloading the poster images and content metadata when it is opened on the digital media receiver 9005. At the same time, the media editing application 770 has been opened on laptop 770. A project 810 has been selected from the library 830. In response to the selection, the media editing application presents a visual representation of the project in the timeline 845. As shown, the user selects the option 850 to publish the project.

At time 3, the project has been rendered to file on the laptop 705. The media editing application 770 might have transcoded multiple versions of the project in different encoding formats (e.g., high-definition and standard definition). The sharing service executing on the laptop 705 has transmitted one or more output versions, its associated metadata, and a poster image to a cloud service (e.g., a storage server). The sharing service executing on the digital media receiver 905 has detected that a new content has been published. The sharing service has also downloaded the poster image 925 and the content metadata and stored them in the receiver's cache storage.

The staging area 920 has (at time 3) been refreshed to show the poster image 925 of the new content. Here, the representation is shown with metadata (e.g., title, creation or publication date) regarding the published content. However, the representation is shown without a progress bar. This is because only the representation and its associated metadata have been downloaded onto the digital media receiver 905. A time 3, the poster image 925 has been selected from the staging area 910. A person then directs the application to play the new content (e.g., by pressing a button on a receiver's remote control). Time 4 shows the new content being streamed with the digital media receiver 905.

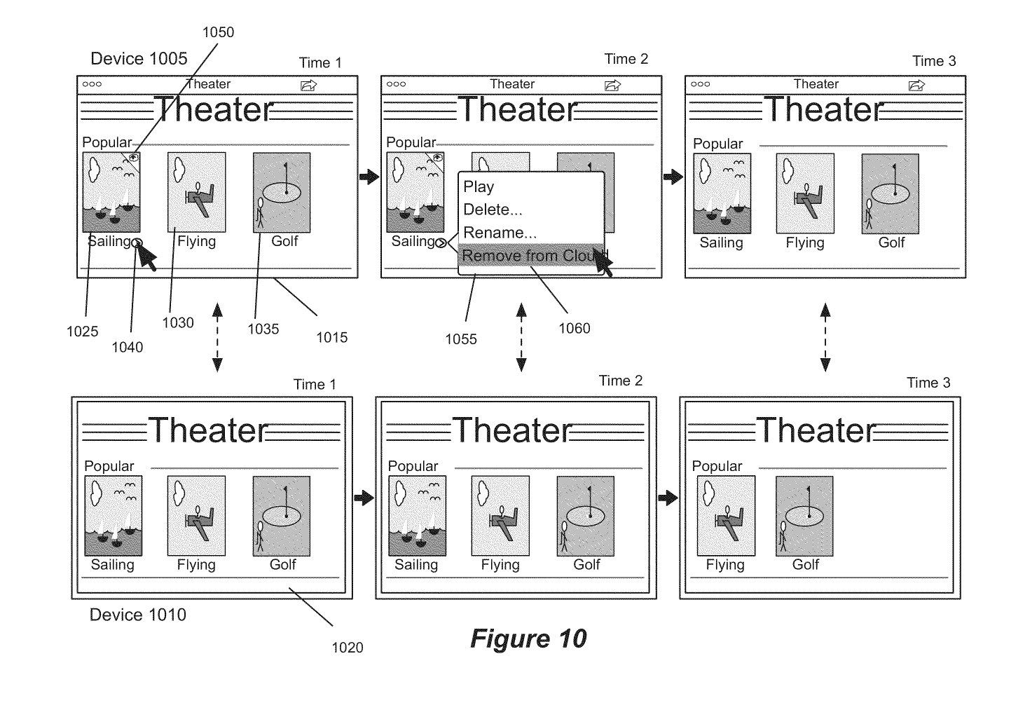

In several of the examples of above, the newly published content is distributed across to other user devices. The virtual staging area of some embodiments provides tools for managing published content. The management can entail deleting the content from the device, deleting it from other devices, and/or renaming the content. FIG. 10 illustrates an example of using one device 1005 to remove the published content on another user device 1010. This figure conceptually illustrates the devices 1005 and 1010 at three different time periods (time 1-time 3). The devices 1005 and 1010 may be at a same location or remote locations.

At time 1, the staging areas 1015 and 1020 have been opened on the devices 1005 and 1010, respectively. Each staging area (1015 or 1020) shows three poster images 1025-1035 of previously published content. In this example, the staging area 1015 of the device 1005 shows the poster image 1025 with a marking 1050 (e.g., an icon). The marking is displayed at least partially over the image and indicates (e.g., through a cloud symbol) that the published content is stored in the cloud (e.g., with a cloud storage service).

The user selects (at time 1) a control 1040 associated with the poster image 1025 from the staging area 1015 to display a context menu 1055. A shown at time 2, the context menu 1055 appears over the staging area 1015 and includes a number of selectable menu items. Specifically, it includes menu items to play the content, delete it, rename it, or remove it from the cloud storage. In some embodiments, when content is changed on one device, the change is propagated across to other device. For instance, when a title of content is changed on one device, the same change will be shown across staging areas of other user devices. Alternatively, the change may not be propagated across to other devices. For instance, when a published content is deleted on one device, that same content and its representation may not be deleted from another device.

At time 2, each staging area (1015 or 1020) shows three poster images 1025-1035 of previously published content. The user selects the menu item 1060 from the context menu 1055 to remove the content from the cloud (e.g., from a cloud storage server). At time 3, the selection resulted in the content and/or its representation being deleted from the device 1010. This is shown with the staging area of the device that shows only the poster images 1025 and 1030 of the two published content. On the other hand, the staging area 1015 of the device 1005 still shows the poster image 1035 of the other content. This is because the content was removed from the cloud (e.g., from the cloud storage service) but not from the device (e.g., from the staging area folder).

When a content is removed from a cloud storage server on one device, the sharing service on each other device may detect a change and perform a synchronizing operation so that the changes is propagated to that device. For instance, in FIG. 10, the sharing service executing on the device 1010 has detected that the content is no longer available in the cloud storage service. The sharing service might have also deleted the content and its associated data from the device 1010. In some embodiments, the sharing service does not delete content from other devices. That is, it maintains all content on each device until the user explicitly directs the device to delete one or more pieces of content. On devices that stream content, a staging area application or the sharing service might detect that the published content is no longer available in the cloud storage so that its representation is no longer shown a staging area.

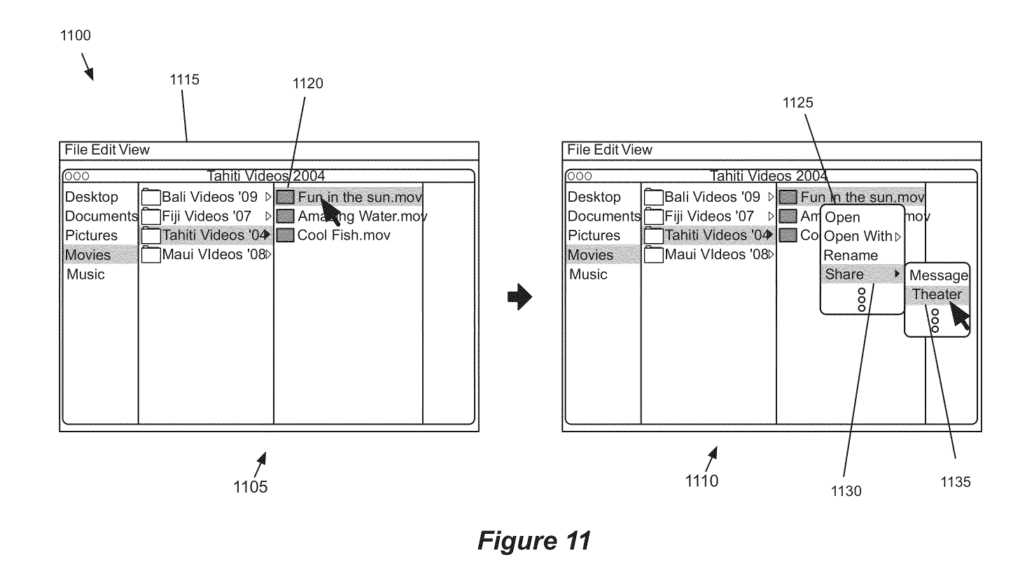

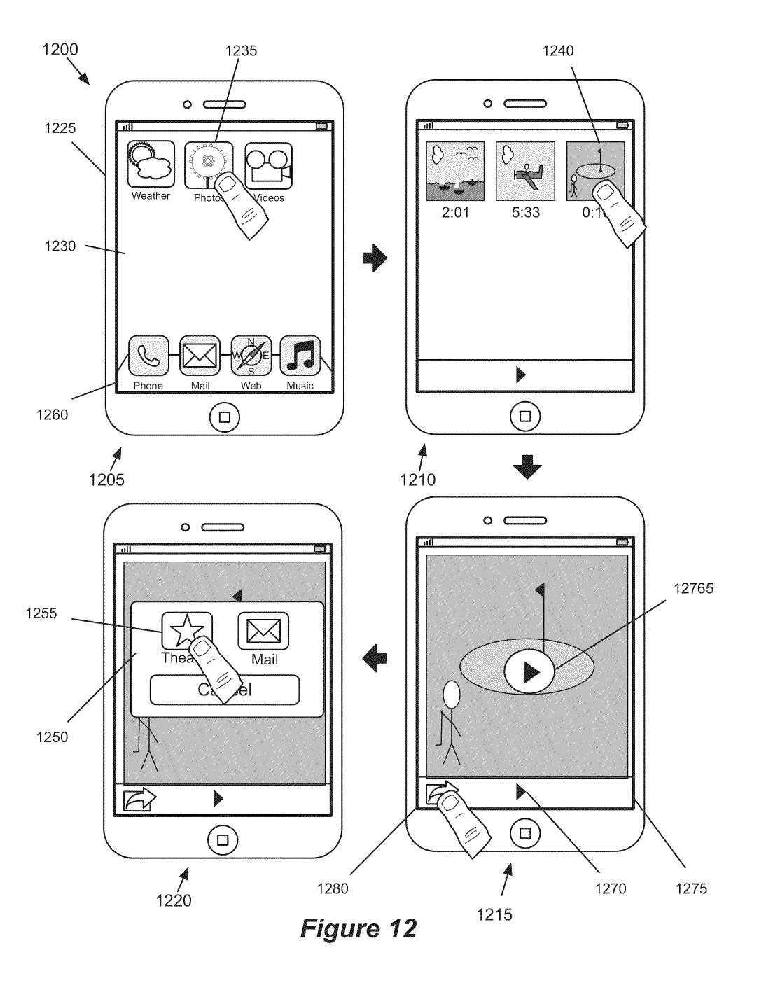

In some embodiments, the sharing service is integrated into one or more applications; and/or is integrated into an operating system. Several such integration examples will now be described below by reference to FIGS. 11-12. FIG. 11 illustrates an example of how the sharing service can be integrated into an operating system. Two operational stages 1105 and 1110 of a device 1100 are shown in this figure.

As shown in the first stage 1105, the device is displaying a file manager 1115 to manage files, disks, network volumes, and launch applications. A file manager widow 1120 has been opened to display a view of content (e.g., a column view). Specifically, the file manager widow 1120 displays a list of folders in the first column. The list includes desktop, documents, pictures, and movies. The movies folder has been selected from the folder list. Accordingly, the file manager widow shows a list of sub-folders in the second column. As a subfolder has been selected from the second column, the third column shows its content.

Three video clip representations are shown in the third column. In the first stage 1105, the user selects the representation 1120 (e.g., through a right-cursor click or a cursor click in conjunction with holding down a key). As shown in the second stage 1110, the selection causes a context menu 1125 to appear.

To simplify the discussion, the context menu 1125 only includes options to open the content, open it with a chosen application, rename it, and share it. In the second stage 1110, the option 1130 to share the content has been chosen with the context menu. The selection resulted in the context menu revealing addition options for sharing the content. As shown, the user chooses the option 1135 to publish the content to a staging area (e.g., a virtual theatre). In the example described above, the sharing service is integrated into an operating system's shell. That is, it is fully implemented as part of the operating system's user interface. The user does not have to open a custom application. The user can simply choose any media item (e.g., a slide show, a video clip, an audio clip) in a particular folder (e.g., a desktop folder) and then choose an option to publish it to the virtual staging area.

FIG. 12 illustrates an example of how the sharing service can be integrated into an application. Specifically, this figure illustrates how the sharing service can be implemented on a mobile device 1200. Four operational stages 1205-1220 of the mobile device 1200 are shown in this figure. In this example, the mobile device is a smart phone. In the first stage 1205, the touch screen of the device is displaying a home screen page 1230. The home screen page 1230 shows a number of icons to launch different applications. Some of the icons are arranged along a dock 1260 that overlays page 1230.

As shown in the first stage 1205, the user directs the smart phone 1200 to launch an application (e.g., photo application) by tapping the user's finger on the touchscreen display over the application icon 1235. The second stage 1210 illustrates that the selection has caused the application to be opened. The application presents thumbnail representations of several media items (e.g., photos, video clips) stored on the smart phone.

In the second stage 1210, the user selects a video clip by tapping the user's finger on the touch screen display over the thumbnail representation 1240. As shown in the third stage 1215, the selection causes the application to present a full-screen representation of the video clip. The full-screen representation is overlaid by a play button 1265 to play the video clip. A similar play button 1270 is shown along a bar (e.g., a bottom bar) 1275. This bar 1275 also includes a share button 1280 to share the video clip.

As shown in the third stage 1265, the user selects the share button 1280. The selection causes the application to display a window 1250 with a list of share options. Each option is presented with an icon and name. From this window 1250, the user selects an option to publish the clip to a staging area by tapping the user's finger on a theater icon 1255. In this example, the sharing service is integrated into a framework of device's operating system. That is, different applications can be implemented that uses the sharing service framework.

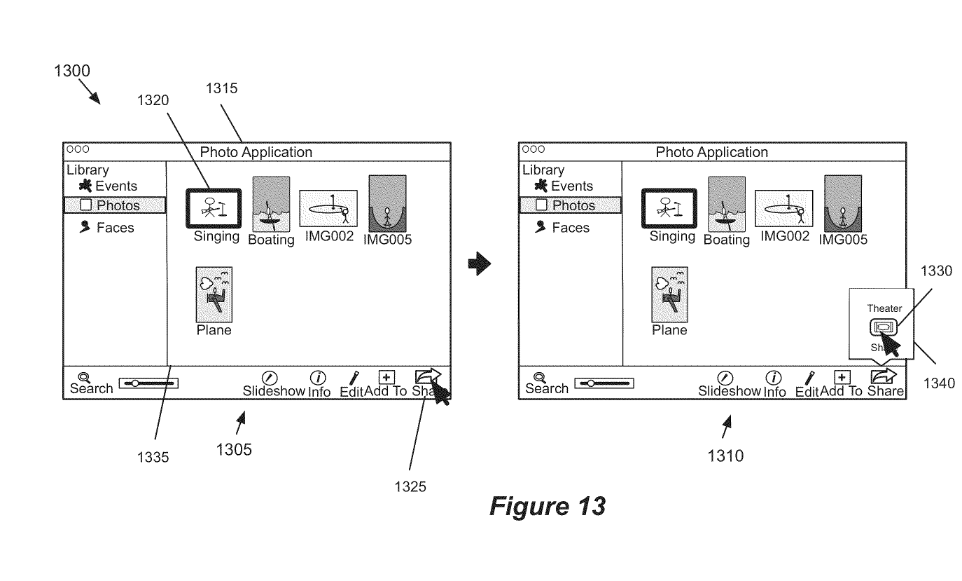

FIG. 13 illustrates another example of how the sharing service can be integrated into an application. Specifically, this figure illustrates how the sharing service can be implemented on an application that executes on a computer (e.g., a desktop computer, a laptop). Two operational stages 1305 and 1310 of the computer 1300 are shown in this figure. In the first stage 1305, an image organizing application 1315 has been opened with the computer 1300. The application's content browser 1335 displays thumbnail representations of several media items. A video clip representation has been selected from the browser 1335.

The first stage 1305 illustrates the selection of an option 1325 (e.g., a share button) to share the selected content. As shown in the second stage 1310, the selection causes the application to display a pop-up window 1330. This window 1330 includes a selectable item 1340 to publish the selected content to a staging area. The user then selects the item 1340 to publish the selected content.

As mentioned above, the sharing service of some embodiments downloads content metadata to present the content in a staging area (e.g., a virtual theatre). FIG. 14 conceptually illustrates content metadata 1400 according to some embodiments. In this example, the content metadata (hereinafter theatre metadata) describes a shared content and its presentation in the virtual staging area across different types of user devices. As mentioned above, there may be multiple versions (e.g., high-definition and standard-definition versions) of the same-shared content.

The theatre metadata 1400 includes a version number and a set of items relating to the shared content. The version number is the metadata version number. The set of items includes (1) a display name (e.g. the title of the shared content), (2) a unique ID of the shared content, (3) a creation date (e.g., the time and date the project was rendered and encoded), (4) an image name (e.g., the name of the poster image), and (5) duration of the shared content. The set of items includes additional metadata, such as play count and last played date.

The set of items is associated with a representation set. The representation set includes one or more streaming URLs to stream the content (e.g., the high-definition or the standard-definition version), a sequence URL (e.g., a reference to the project from which the content is generated) and version qualities (e.g., 480p, 720p, 1080p, 2000p, 2160p, etc.). The representation set may also include a type (e.g., audio content, video content, slideshow content) and last played date.

The sequence URL of some embodiments is used to display a selectable item in a staging area for opening the original project. The sequence URL may also be used to detect duplicates. For example, if a person modifies a project that has been previously published, the media editing application identifies that the sequence is the same and replaces one or more published versions with new updated versions. In this manner, the stating areas of different user devices are not cluttered with different version of the same project.

In some embodiments, each staging area uses some or all of the metadata to present content. As a first example, the staging area might use the play count to sort the published content by popularity, might use the creation date to sort by date, display name to sort by title, etc. In some embodiments, the metadata is serialized in some format from an originating user device and transferred to a control server. The control server then pushes the metadata (e.g., in the serialized format) to other user devices. In some embodiments, when an update to a content metadata is detected, the update is pushed to other user device. For example, a change in a play count and/or last play date can result in user devices receiving the updated content metadata.

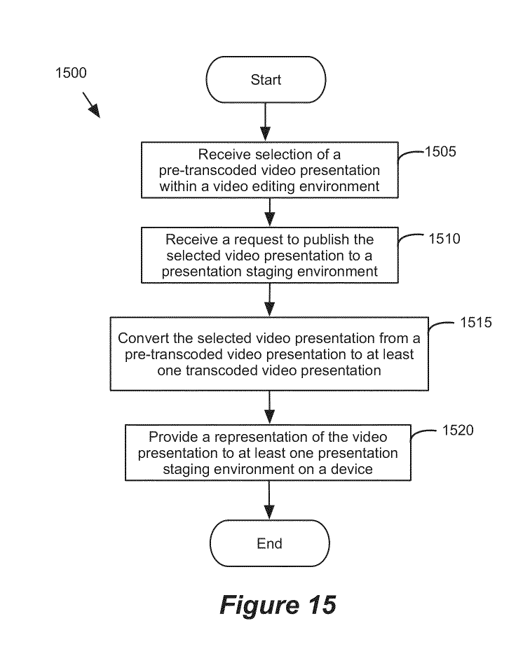

As mentioned above, the virtual staging area of some embodiments is formed by staging areas of multiple different devices (e.g., a smart phone, a tablet, a digital media receiver, a laptop, a personal computer, etc.) in which a same set of content can be viewed. In some embodiments, the devices are all associated with one user. The content may be a video presentation (e.g., a video presentation project) that the user is authoring with a media editing application. FIG. 15 conceptually illustrates a process 1500 that some embodiments use to publish a video presentation. The process 1500 of some embodiments is performed by the media editing application.

The process 1500 begins when it receives (at 1505) selection of a pre-transcoded video presentation. For example, a person might select or open a particular project through a user interface (UI) of the media editing application. The process 1500 then receives (at 1510) a request to publish the selected video presentation to a presentation staging environment (also referred to herein as a virtual staging area). In some embodiments, the video editing environment is different from the video staging environment. For instance, the video editing environment provides various tools to edit a video presentation. Different from the video editing environment, the video staging environment of some embodiments provides a staging area (a virtual theatre) with representations (e.g., poster image) of different video presentations.

At 1515, the process 1500 converts the selected video presentation from a pre-transcoded video presentation to at least one transcoded video presentation. As mentioned above, the process might generate multiple transcoded versions (e.g., high-definition version, standard-definition version, etc.).

The process 1500 then provides (at 1520) a representation of the video presentation to at least one presentation-staging environment on a device. In some embodiments, the process 1500 publishes the transcoded video presentation by providing the representation to the presentation-staging environment on multiple devices. For example, the process might provide a representation of a video presentation to a first presentation staging environment on one device and provide the representation to a second staging environment on another device. Publishing the video presentation to the first and second presentation staging environments enable viewing of the transcoded video presentation respectively on first and second devices.

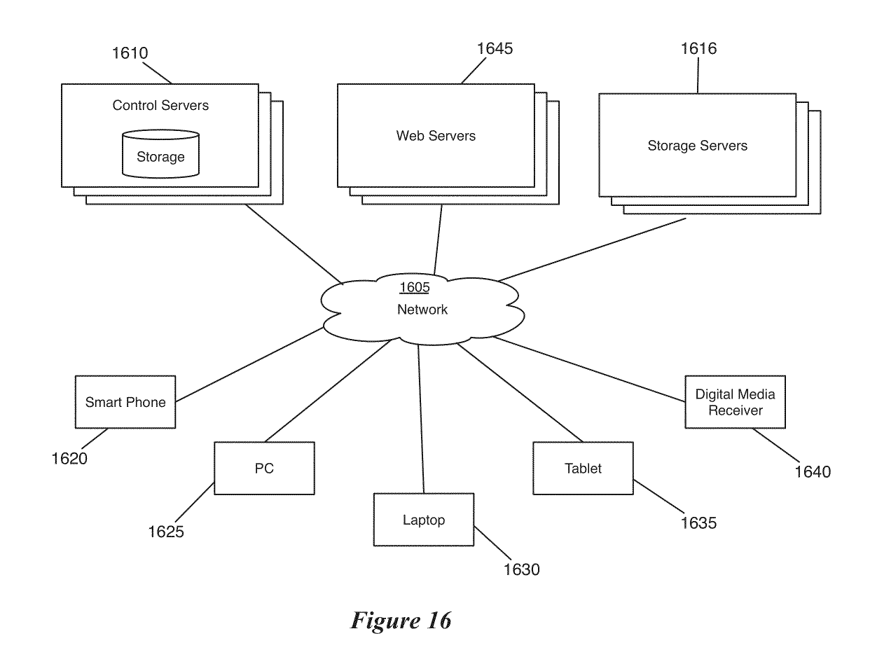

In some embodiments, the sharing service is implemented across different user devices and/or different platforms (e.g., from different vendors). To facilitate the content sharing operations, the devices (hereinafter clients) may communicate with several different servers. These servers may include storage servers (e.g., third-party storage servers), control servers, and web servers. FIG. 16 conceptually illustrates an example system architecture in which the clients communicate with the different servers to share content.

As shown in FIG. 16, the figure includes different clients 1620-1640, a set of control servers 1610, a set of web servers 1645, and a set of storage servers 1616. The clients are different computing devices that communicate with the control and storage servers over network 1605. In some embodiments, the clients are associated with one user that is registered with a cloud service provider. In the example illustrated in FIG. 16, the clients are a variety of heterogamous devices, including smart phone 1620, a laptop 1630 (e.g., that operates on a MAC OS), a personal computer 1625 (e.g., that operate on a Windows OS), a tablet 1635, and a digital media receiver 1640. However, a client can be one of any number of different types of devices, such as a Personal Data Assistant (PDA), a workstation, etc.

The set of storage servers 1616 stores shared content for distribution to different clients. The set of storages may be contracted by the cloud service provider (e.g., that manages the set of control servers 1610 and the set of web servers). According, the set of storage servers may be a set of third-party servers. To facilitate the storage service, the set of third-party storage servers may be associated with an application program interface (API). The client devices may use this API to store and receive content.

The set of control servers 1610 manages control data associated with the different clients. Examples of such control data include user data and content metadata. The user data may include a list of user devices registered with the cloud service provider. For example, each of the devices (e.g., through its device ID) may be associated with the user (e.g., through the user ID). The control data may include references to content that are stored by the set of storage servers 1616. Thus, the set of control servers may maintain information relating to the virtual staging area, while not storing any of the content associated with the virtual staging area. To manage control data, each control server is associated with one or more storages (e.g., data stores). In some embodiments, the control server and the one or more storages is a logical partition in which data relating a particular user resides.

In some embodiments, the control server is configured to receive notifications from a client that one or more files are to be transmitted from the client. In response to such a notification, the control server sends, to the client, storage location data that indicates where the one or more files are to be sent. The storage location data may be data associated with a storage server. The client uses the storage location data to transmit the one or more files to the storage service.

The control server of some embodiments is a push server that pushes notifications (e.g., event triggers) to clients. For instance, when content is published on one device, the control server is notified of that update. The control server then sends messages to all of the other user devices registered with the cloud service provider. These other devices then retrieve the content data and/or poster image from the set of storage servers 1616.

Some or all of these devices may be logged on as a control-server clients at all times. For example, the sharing server may operate as a background to distribute content and receive new content (e.g., even when the theater application or media editing application has been closed). Also, one or more of the clients (e.g., digital media players) may not have direct access to the set of control server. Instead, these clients access the set of control server indirectly through the set of web servers. The set of web server may also send these clients staging area data (e.g., webpage data). Each client then generates a view of the staging area using that staging area data.

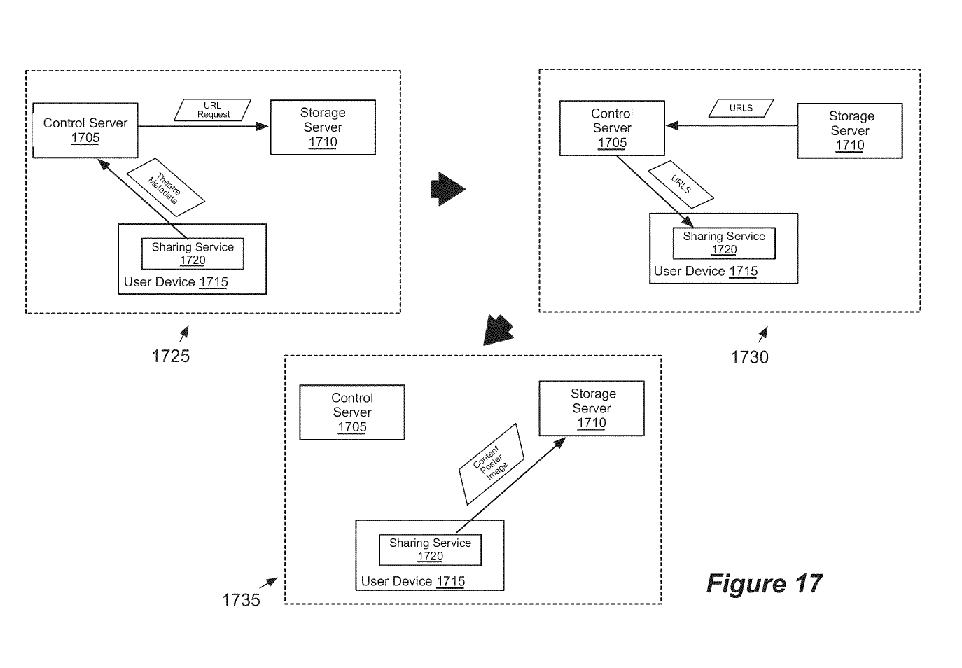

Having described an example distribution model, several operations will now be described below by reference to FIGS. 17-22. The sharing service then publishes the content to the device's staging area. FIG. 17 conceptually illustrates an example of how content stored on one user device is sent to a storage sever for distribution to other user devices. The figure shows a control server 1705, a storage server 1710, and a user device 1720. The sharing service 1720 executes on the device (e.g., as a daemon process) to facilitate the distribution of content. Three-communication stages 1725-1735 are illustrated in this figure.

The first stage 1725 illustrates the system after a piece of content has been published to a staging area of the user device 1720. The sharing service 1720 detects that a new content has been added to the staging area. The sharing service 1720 then sends content metadata. The control server 1705 receives the metadata and stores some or all of its data and requests the storage server for one or more URLs (e.g., for different versions of the content, poster image). To simplify the discussion, only one message is shown in this and the following two figures. However, there can be many messages between these servers and/or devices.

The second stage 1730 illustrates the system after the URL request has been received by the storage server 1710. Having received the request, the storage server 1710 then sends one or more messages with storage location information (e.g., URLs) to upload content. The control server stores the storage location information and then sends the storage location information to the user device 1715. As shown in the third stage 1735, through the sharing service 1720, the user device 1715 then upload the content and poster image using the storage location information.

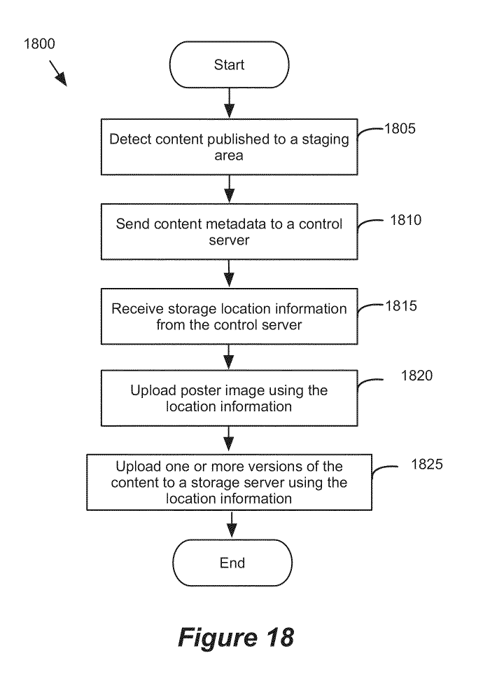

FIG. 18 conceptually illustrates a process 1800 that some embodiments use to publish content to the cloud. The process 1800 is performed by a sharing service that operates on a client device. The process 1800 begins when it detects (at 1805) content published to the device's staging area. The process 1800 then sends (at 1810) content metadata to a control server. A client device may be logged on as a control-server clients at all times through username and password authentication. The sharing server may operate in the background to detect changes and send messages to the control server regarding those changes.

At 1815, the process 1800 receives storage location information from the control server. The process 1800 then uploads (1820) the poster image to the storage server using the storage location information. The process 1800 then uploads (1825) one or more version of the content to a storage server using the storage location information. The process 1800 then ends. One reason for uploading the poster image prior to the content is that it allow for immediate feedback on other staging areas of other user devices. For example, the rendering, transcoding, and uploading of different versions might take some time. On the other hand, the poster image file and the metadata file are relatively small (e.g., in bytes) as compared to the transcoded versions, and can be pushed to the cloud rather quickly. Once pushed, the poster image then appears on the other staging areas of the other devices prior to one or more versions of the content being available in the cloud (e.g., a cloud storage server).

Some embodiments perform variations of the process 1800. The specific operations of the process may not be performed in the exact order shown and described. The specific operations may not be performed in one continuous series of operations, and different specific operations may be performed in different embodiments.

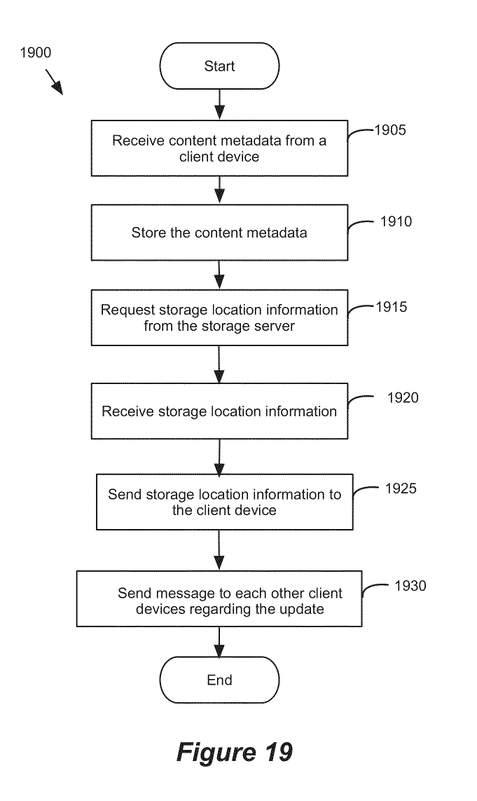

FIG. 19 conceptually illustrates a process 1900 that some embodiments use to publish content to the cloud. The process 1900 is performed by the control server that manages the distribution of content across user devices. The process 1900 begins when it receives (at 1905) content metadata from a client device. The process 1900 then stores (at 1910) the content metadata. Based on the content metadata, the process requests (at 1915) storage location information from the storage server.

At 1920, the process 1900 receives storages information from the storage server. The process 1900 then sends (at 1915) the storage location information to the client device. The process then sends a message to each other client or user device. The process 1900 then ends.

Some embodiments perform variations of the process 1900. The specific operations of the process may not be performed in the exact order shown and described. The specific operations may not be performed in one continuous series of operations, and different specific operations may be performed in different embodiments.

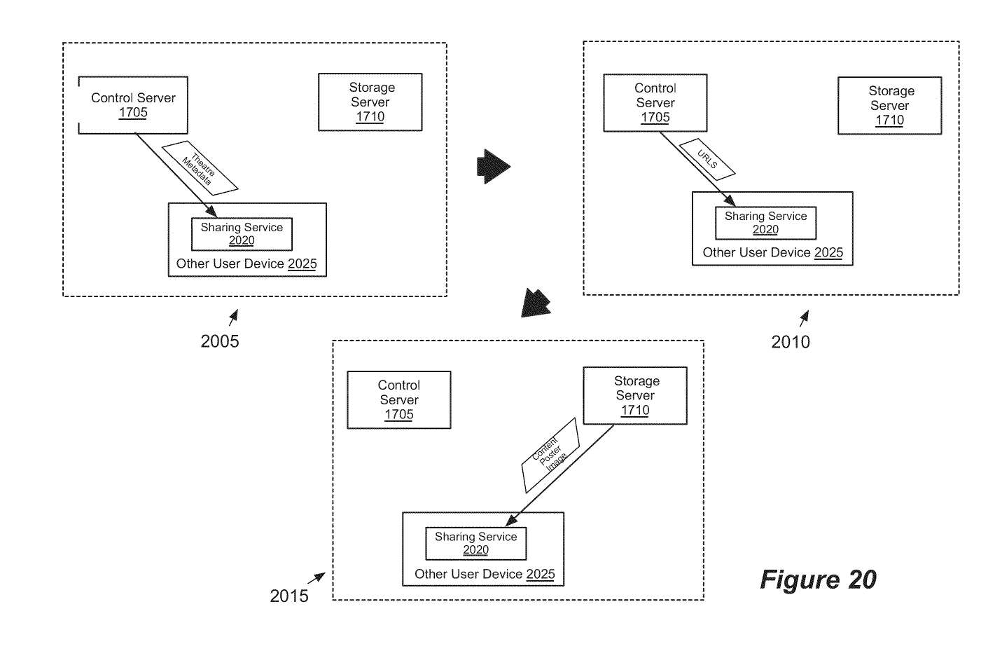

As mentioned above, some devices automatically download and store the content for viewing at any time. FIG. 20 illustrates an example of how such a device downloads content from a storage server. The figure shows the same control and storage servers 1705 and 1710 but show a different user device 2025 that is registered with the cloud service provider. Three-communication stages 2005-2015 are illustrated in this figure.

The first stage 2005 illustrates the system after the content and the poster image have been uploaded to the storage server 1710. The sharing service 2020 is notified that there is a new content by the control server 1705. The sharing service 2020 also receives the content metadata from the control server.

As shown in the second stage 2010, the control server sends the storage location information to the device. In some embodiments, the storage location information may be contained in the content metadata. In the third stage 2015, through the sharing service 2020, the user device 2025 then downloads the content and poster image using the storage location information.

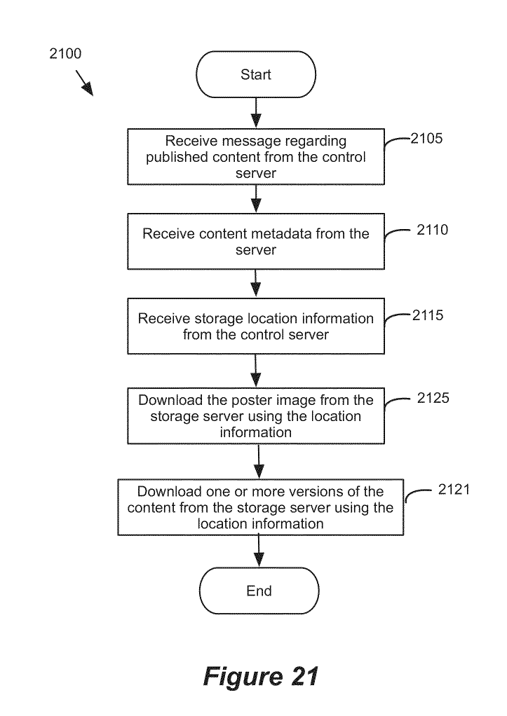

FIG. 21 conceptually illustrates a process 2100 that some embodiments use to push content to other client devices. The process 2100 is performed by a client device. The process 2100 begins when it receives (at 2105) a message (e.g., an asynchronous notification) regarding a published content. The process 2100 receives (at 2110) a message regarding a published content. The process 2100 also receives (at 2115) storage location information from the control server. The process 2100 downloads (at 2121) the poster image using the storage location information. The process 2100 then downloads (at 2121) one or more version of the content from the storage server using the storage location information. The process 2100 then ends.

Some embodiments perform variations of the process 2100. The specific operations of the process may not be performed in the exact order shown and described. The specific operations may not be performed in one continuous series of operations, and different specific operations may be performed in different embodiments.

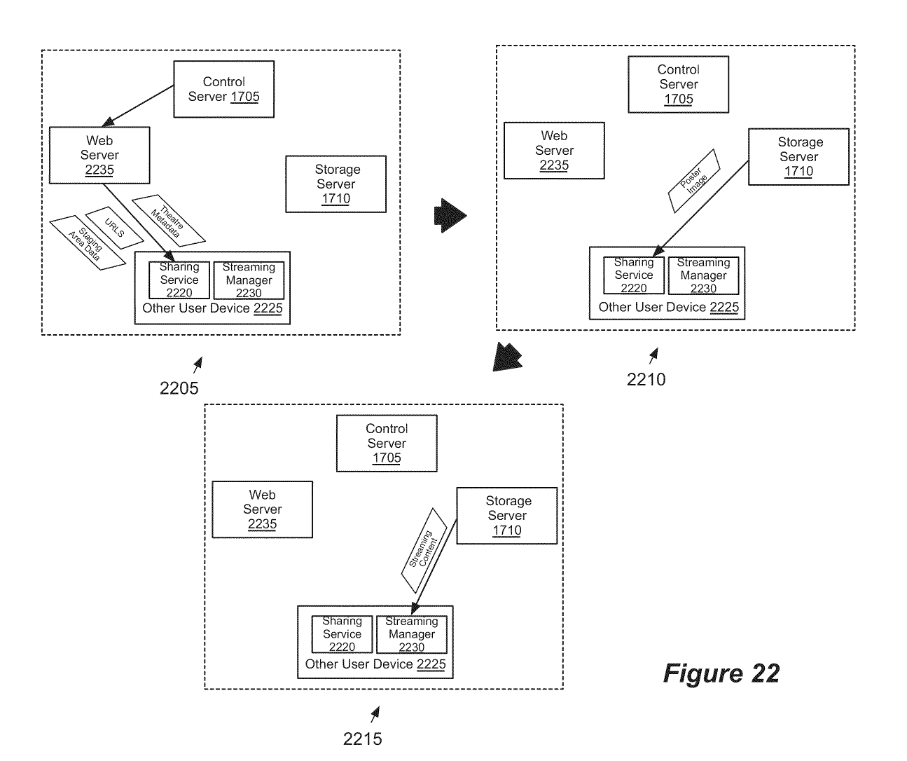

Some user devices do not automatically download the content data. Instead, they just download other data (e.g., poster image, content metadata) to the display the content in the staging area. FIG. 22 illustrates an example of how such a device streams content from a storage server. The figure shows the same control and storage servers 1705 and 1710 but shows a yet another user device 2225 that is registered with the cloud service provider. The sharing service 1720 executes on the device (e.g., as a daemon process) to facilitate the streaming. The streaming manger 2230 execute on the device to stream content. In this example, the device 2225 communicates with the control server 1705 through a web server 2235.

The first stage 2205 illustrates the system after the content and the poster image have been uploaded to the storage server 1710. The sharing service 2220 is notified that there is a new content by the control server 1710 via the web server 2235. The sharing service 2220 also receives the content metadata and the URL from the web server 2235. The web server 2235 receives the content metadata and the storage location information from the control server 1705. The web server then sends the content metadata and the storage location information to the user device. 2225. In some embodiments, the web server also sends staging area data (e.g., webpage data). The user device uses the staging area data to generate a virtual interface for the staging area.

The third stage illustrates the user device 2225 downloading the poster image through the sharing service 2220. The poster image (e.g., and the staging area data) is then used to generate a view of the staging area. The poster image can then be selected from the staging area to stream the content. The third stage illustrates the content being streamed with the streaming manager 2225.

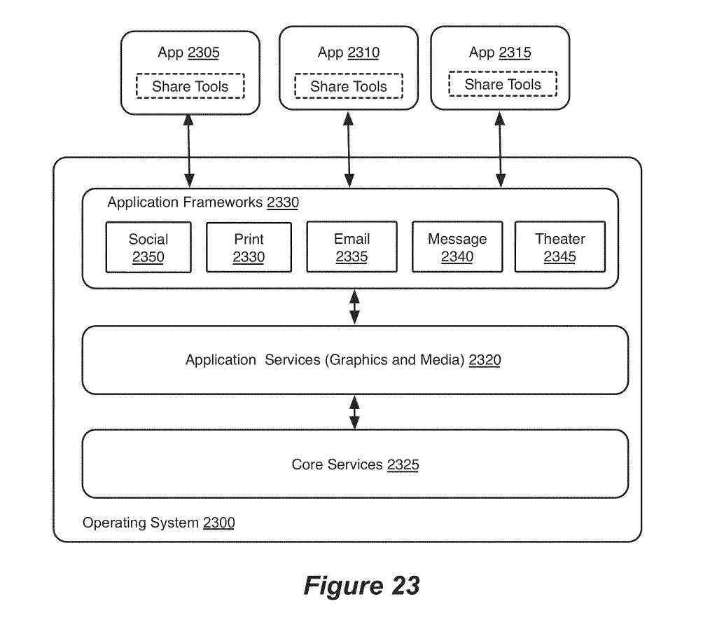

To facilitate the virtual staging area, some embodiments provide a sharing service that runs on each of the different devices. The sharing service of some embodiments allows a person to choose a piece of content stored on a device. The sharing service then publishes the content to the device's staging area. In some embodiments, the sharing service is implemented within an operating system (“OS”). FIG. 23 conceptually illustrates a software architecture of the share service of some embodiments. As shown, the figure includes an OS 2300 and several applications 2305-2315 that runs on the OS. The OS 2300 is defined by several layers. To simplify the discussion, only three layers are shown in the figure, namely a set of application frameworks 2330, a set of application services 2320, and a set of core services 2325.

The set of core services 2325 provides many low-level features that are used by services at the higher layers. In some embodiments, the set of core services 2325 encompasses kernel environment, drivers, and low-level interfaces of the OS 2300. The set of core services 2325 may also include a security framework to control security, a radio communication framework to communicate through radio, etc. The set of application services 2320 in some embodiments includes services relating to graphics, audio, and video. The set of application services 2320 may include 2D and 3D video processing. The set of application services 2320 may include an asset library framework to access media stored on a device, a media player framework to play media content, etc.

The set of application frameworks 2330 includes the primary frameworks, application program interface (API), and/or toolkits for building applications. In some embodiments, the set of application frameworks 2330 includes different services for multitasking, touch-based input, push notifications, etc. In the example of FIG. 23, the set of application frameworks includes a number of sharing services. Specifically, the sharing services include (1) a social network service 2350 for sharing content through different social networks, (2) a print service 2330 for printing content to a printer, (3) an email service 2335 for sharing content through emails, (4) a message service for sharing content via text message, and (5) a theatre service 2345 for publishing content to the virtual staging area. In some embodiments, each sharing service is provided as part of one individual framework. For example, the set of application frameworks may include a social network framework, a print service framework, a theatre framework, etc. Alternatively, two or more of the sharing services may be grouped in a single application framework.

The applications 2305-2315 run on the OS 2300 (e.g., using the set of application frameworks 2330. For illustrative purposes, each of the application is shown with share tools. The share tools represent the different share services, such as the print service, the email service, the theater service, etc. As an example, the application 2305 may include a share button that when selected provides a selectable item for each of the different share services. The user can then choose a piece of content and select a share service item (e.g., a button, an icon) to share or publish the piece of content (e.g., to the virtual theatre).

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. In addition, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

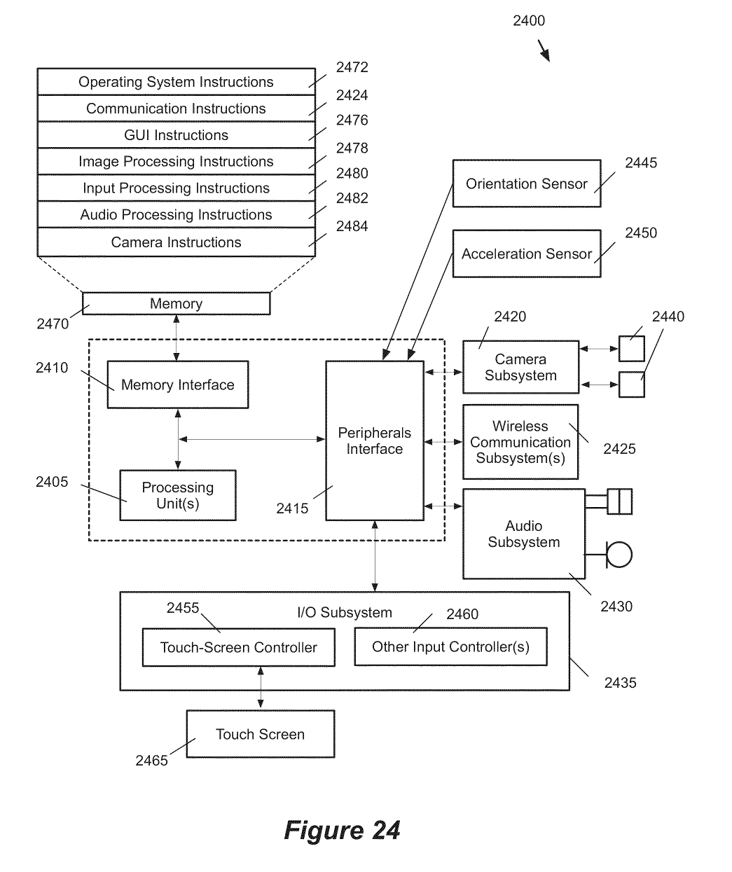

The reminder application of some embodiments operates on mobile devices. FIG. 24 is an example of an architecture 2400 of such a mobile computing device. Examples of mobile computing devices include smartphones, tablets, laptops, etc. As shown, the mobile computing device 2400 includes one or more processing units 2405, a memory interface 2410 and a peripherals interface 2415.

The peripherals interface 2415 is coupled to various sensors and subsystems, including a camera subsystem 2420, a wireless communication subsystem(s) 2425, an audio subsystem 2430, an I/O subsystem 2435, etc. The peripherals interface 2415 enables communication between the processing units 2405 and various peripherals. For example, an orientation sensor 2445 (e.g., a gyroscope) and an acceleration sensor 2450 (e.g., an accelerometer) is coupled to the peripherals interface 2415 to facilitate orientation and acceleration functions.

The camera subsystem 2420 is coupled to one or more optical sensors 2440 (e.g., a charged coupled device (CCD) optical sensor, a complementary metal-oxide-semiconductor (CMOS) optical sensor, etc.). The camera subsystem 2420 coupled with the optical sensors 2440 facilitates camera functions, such as image and/or video data capturing. The wireless communication subsystem 2425 serves to facilitate communication functions. In some embodiments, the wireless communication subsystem 2425 includes radio frequency receivers and transmitters, and optical receivers and transmitters (not shown in FIG. 24). These receivers and transmitters of some embodiments are implemented to operate over one or more communication networks such as a GSM network, a Wi-Fi network, a Bluetooth network, etc. The audio subsystem 2430 is coupled to a speaker to output audio. Additionally, the audio subsystem 2430 is coupled to a microphone to facilitate voice-enabled functions, such as voice recognition, digital recording, etc.

The I/O subsystem 2435 involves the transfer between input/output peripheral devices, such as a display, a touchscreen, etc., and the data bus of the processing units 2405 through the peripherals interface 2415. The I/O subsystem 2435 includes a touch-screen controller 2455 and other input controllers 2460 to facilitate the transfer between input/output peripheral devices and the data bus of the processing units 2405. As shown, the touch-screen controller 2455 is coupled to a touchscreen 2465. The touch-screen controller 2455 detects contact and movement on the touchscreen 2465 using any of multiple touch sensitivity technologies. The other input controllers 2460 are coupled to other input/control devices, such as one or more buttons. Some embodiments include a near-touch sensitive screen and a corresponding controller that can detect near-touch interactions instead of or in addition to touch interactions.

The memory interface 2410 is coupled to memory 2470. In some embodiments, the memory 2470 includes volatile memory (e.g., high-speed random access memory), non-volatile memory (e.g., flash memory), a combination of volatile and non-volatile memory, and/or any other type of memory. As illustrated in FIG. 24, the memory 2470 stores an operating system (OS) 2472. The OS 2472 includes instructions for handling basic system services and for performing hardware dependent tasks.

The memory 2470 also includes communication instructions 2474 to facilitate communicating with one or more additional devices; graphical user interface instructions 2476 to facilitate graphic user interface processing; image processing instructions 2478 to facilitate image-related processing and functions; input processing instructions 2480 to facilitate input-related (e.g., touch input) processes and functions; audio processing instructions 2482 to facilitate audio-related processes and functions; and camera instructions 2484 to facilitate camera-related processes and functions. The instructions described above are merely exemplary and the memory 2470 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 24 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 24 may be split into two or more integrated circuits.

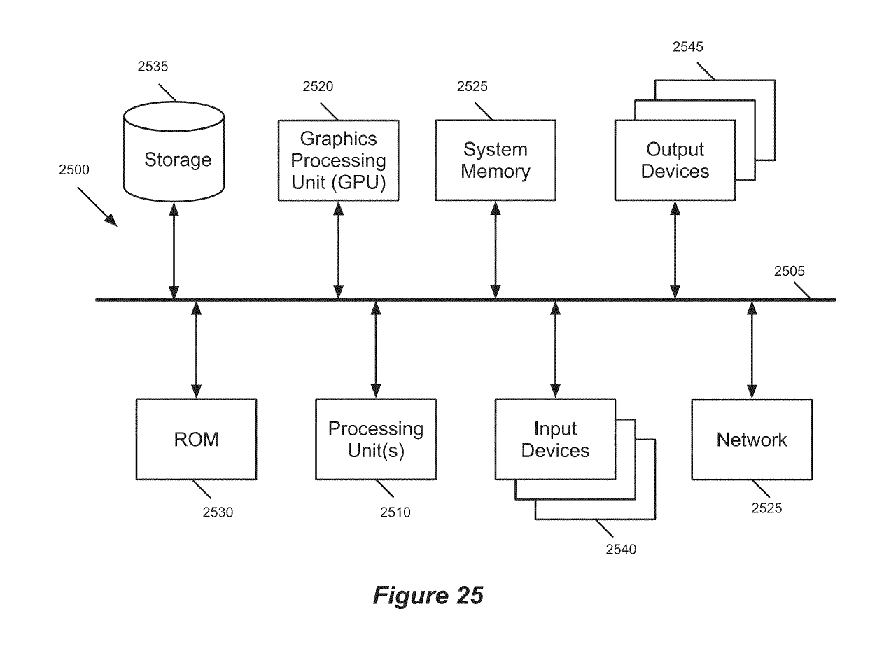

FIG. 25 conceptually illustrates another example of an electronic system 2500 with which some embodiments of the invention is implemented. The electronic system 2500 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2500 includes a bus 2505, processing unit(s) 2510, a graphics processing unit (GPU) 2515, a system memory 2520, a network 2525, a read-only memory 2530, a permanent storage device 2535, input devices 2540, and output devices 2545.

The bus 2505 collectively represents all system, peripheral, and chipset buses that communicatively connect the numerous internal devices of the electronic system 2500. For instance, the bus 2505 communicatively connects the processing unit(s) 2510 with the read-only memory 2530, the GPU 2515, the system memory 2520, and the permanent storage device 2535.

From these various memory units, the processing unit(s) 2510 retrieves instructions to execute and data to process in order to execute the processes of the invention. The processing unit(s) may be a single processor or a multi-core processor in different embodiments. Some instructions are passed to and executed by the GPU 2515. The GPU 2515 can offload various computations or complement the image processing provided by the processing unit(s) 2510.

The read-only-memory (ROM) 2530 stores static data and instructions that are needed by the processing unit(s) 2510 and other modules of the electronic system. The permanent storage device 2535, on the other hand, is a read-and-write memory device. This device is a non-volatile memory unit that stores instructions and data even when the electronic system 2500 is off. Some embodiments of the invention use a mass-storage device (such as a magnetic or optical disk and its corresponding disk drive) as the permanent storage device 2535.

Other embodiments use a removable storage device (such as a floppy disk, flash memory device, etc., and its corresponding drive) as the permanent storage device. Like the permanent storage device 2535, the system memory 2520 is a read-and-write memory device. However, unlike storage device 2535, the system memory 2520 is a volatile read-and-write memory, such a random access memory. The system memory 2520 stores some of the instructions and data that the processor needs at runtime. In some embodiments, the invention's processes are stored in the system memory 2520, the permanent storage device 2535, and/or the read-only memory 2530. For example, the various memory units include instructions for processing multimedia clips in accordance with some embodiments. From these various memory units, the processing unit(s) 2510 retrieves instructions to execute and data to process in order to execute the processes of some embodiments.

The bus 2505 also connects to the input and output devices 2540 and 2545. The input devices 2540 enable the user to communicate information and select commands to the electronic system. The input devices 2540 include alphanumeric keyboards and pointing devices (also called “cursor control devices”), cameras (e.g., webcams), microphones or similar devices for receiving voice commands, etc. The output devices 2545 display images generated by the electronic system or otherwise output data. The output devices 2545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 25, bus 2505 also couples electronic system 2500 to a network 2525 through a network adapter (not shown). In this manner, the computer can be a part of a network of computers (such as a local area network (“LAN”), a wide area network (“WAN”), or an Intranet, or a network of networks, such as the Internet. Any or all components of electronic system 2500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (including FIGS. 6, 15, 18, 19, and 21) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention can be embodied in other specific forms without departing from the spirit of the invention. For example, one of ordinary skill in the art will understand that many of the UI items of in FIGS. 1, 4, 5, 7, 8, 9, 10, 11, 12, and 13) can also be activated and/or set by a cursor control device (e.g., a mouse or trackball), a stylus, keyboard, a finger gesture (e.g., placing, pointing, tapping one or more fingers) near a near-touch sensitive screen, or any other control system in some embodiments. Thus, one of ordinary skill in the art would understand that the invention is not to be limited by the foregoing illustrative details, but rather is to be defined by the appended claims.

What is claimed is:

1. A non-transitory machine readable medium storing a program for presenting video, the program for execution by at least one processing unit, the program comprising sets of instructions for:
receiving a selection of a pre-transcoded video presentation within a video editing environment;
receiving a request to publish the selected video presentation to a presentation staging environment that is different from the video editing environment;
converting the selected video presentation from a pre-transcoded video presentation to a transcoded video presentation; and
publishing the video presentation by providing a representation of the video presentation to a first presentation staging environment on a first device and providing the representation to a second presentation environment on a second device, wherein publishing the video presentation to the first and second presentation staging environments enable viewing of the transcoded video presentation respectively on first and second devices.

2. The non-transitory machine readable medium of claim 1, wherein the set of instructions for receiving the request comprises a set of instructions for receiving the request on the first device.

3. The non-transitory machine readable medium of claim 1, wherein the program further comprises a set of instructions for performing video editing operations to define the pre-transcoded video presentation on the first device by reference to different video clips.

4. The non-transitory machine readable medium of claim 3, wherein the program further comprises a set of instructions for rendering the video presentation by compositing the video clips prior to transcoding the video presentation in order to publish the video presentation to the presentation staging environment.

5. The non-transitory machine readable medium of claim 1, wherein the program is a non-linear video editing application.

6. The non-transitory machine readable medium of claim 1, wherein the transcoded video presentation is a first transcoded video presentation, wherein the set of instructions for converting comprises a set of instructions for transcoding a second transcoded video presentation from the selected video presentation, wherein publishing the video presentation to the second presentation staging environments enable viewing of the first and the second transcoded video presentations on the second device.

7. The non-transitory machine readable medium of claim 1, wherein the presentation staging environment is a virtual staging area formed by the first presentation staging environment on the first device and the second staging environment on the second device.

8. The non-transitory machine readable medium of claim 7, wherein the first and second staging environments have similar appearances to emulate one common virtual staging area.

9. The non-transitory machine readable medium of claim 8, wherein the first and second staging environments have the appearance of a movie theater.

10. The non-transitory machine readable medium of claim 1,
wherein the program executes on the first device,
wherein the first device and the second device are communicatively coupled to a set of servers through a communication network,
wherein the set of instructions for publishing the video presentation comprises a set of instructions for uploading the transcoded video presentation to the set of servers for subsequent download of the transcoded video presentation to the second device, said second device storing the downloaded video presentation for subsequent display.

11. The non-transitory machine readable medium of claim 10, wherein the set of servers stores the video presentation in order to stream the video presentation upon request to a third device, said third device comprising a third staging environment for staging a representation of the video presentation.

12. The non-transitory machine readable medium of claim 1, wherein each representation in the corresponding staging environment is a selectable item for playing the transcoded video presentation.

13. A method of presenting video across devices, the method comprising:
receiving selection of a video presentation;
receiving a request to publish the video presentation to a staging area;
publishing the video presentation by providing a representation of the video presentation to a first staging area displayed on a first device and a representation of the video presentation to a second staging area on a second device.

14. The method of claim 13, wherein receiving the request receiving the request on the first device.

15. The method of claim 13 further comprising performing video editing operations to define the video presentation on the first device by reference to different video clips.

16. The method of claim 15 further comprising rendering the video presentation by compositing the video clips before publishing the rendered video presentation to the first and second staging areas.

17. A non-transitory machine readable medium storing a program for presenting video, the program for execution by at least one processing unit of a first device, the program comprising sets of instructions for:
receiving, at the first device, a notification regarding a publication of a video presentation, wherein the publication is initiated from a second remote device;
receiving, at the first device, content metadata for the video presentation from the second device;
receiving, at the first device, a poster image of the video presentation from the second device; and
presenting, on the first device, a virtual movie theatre based on the content metadata and the poster image, wherein the poster image is a selectable item, in the virtual movie theatre, to play the published video presentation.

18. The non-transitory machine readable medium of claim 17, wherein the notification, the content metadata, and the poster image is received at the first device without any user input on the first device during the publication of the video presentation.

19. The non-transitory machine readable medium of claim 17, wherein the program further comprises sets of instructions for:
receiving a selection of the poster image in the virtual movie theatre; and
playing the video presentation in the virtual movie theatre by streaming the video presentation.

20. The non-transitory machine readable medium of claim 17, wherein the program further comprises sets of instructions for:
downloading a transcoded version of the video presentation;
receiving a selection of the poster image in the virtual movie theatre; and
playing the transcoded version of the video presentation in the virtual movie theatre.
